(19) United States
(12) Patent Application Publication
(10) Pub. No.: US 2020/0362176 A1
(43) Pub. Date: Nov. 19, 2020

(54) POROUS POLYMER COATINGS

(71) Applicant: Precision Fabrics Group, Inc., Greensboro, NC (US)

(72) Inventors: Zareh Mikaelian, High Point, NC (US); Chester Wiese, Westfield, NC (US)

(21) Appl. No.: 16/966,395

(22) PCT Filed: Jan. 31, 2019
(86) PCT No.: PCT/US2019/015940

§ 371 Date: Jul. 30, 2020

Related U.S. Application Data
(60) Provisional application No. 62/624,353, filed on Jan. 31, 2018.

(51) Int. Cl. C09D 5/00; C08K 3/013; C08K 3/34; C08J 9/00; B32B 5/02; B32B 5/20; B32B 5/24; B32B 5/26

(52) U.S. Cl. CPC C09D 5/00; B32B 2605/00; C08K 3/346; C08J 9/0019; B32B 5/022; B32B 5/20; B32B 5/245; B32B 5/26; C08K 2201/005; C08K 2201/016; C08J 2207/02; C08J 2327/06; C08J 2327/08; C08J 2300/22; C08J 2300/24; B32B 2250/03; B32B 2255/02; B32B 2255/26; B32B 2307/3065; B32B 2307/724; C08K 3/013

(57) ABSTRACT

The present invention provides porous polymer coatings having adhesive and air flow resistive properties. The porous polymer coating comprises a polymeric foam having a void fraction of greater than about 15% and an air permeability greater than 3 cubic feet per minute per square foot as measured based on ASTM D737-04, wherein the polymeric foam comprises a clay and/or pigment optionally having an aspect ratio of about 2:1, 5:1, or 10:1 to about 20:1, 50:1, or 100:1. In some embodiments, the porous polymer coating comprises a chlorinated polymer and a fluorochemical.

### RELATED APPLICATION INFORMATION

This application claims the benefit of U.S. Provisional Patent Application Ser. No. 62/624,353, filed Jan. 31, 2018, the disclosure of which is incorporated herein by reference in its entirety.

### FIELD OF THE INVENTION

The present application relates to porous polymer coatings.

### BACKGROUND

Acoustically effective materials are used in a variety of applications and products, including, but not limited to, transportation applications, building applications, architectural applications, automobiles, heavy equipment, bus, rail transport vehicles, aircraft, air ducts, appliances, baffles, ceiling tiles and office partitions.

An acoustically effective facing may be applied to a substrate to impart and/or adjust one or more acoustic properties of the substrate. Exemplary acoustic facings are described in U.S. Patent Publication Nos. 2010/0147621 and 2013/0186706 and U.S. Pat. Nos. 8,403,108, 8,439,161, and 8,607,929; the disclosure of each of which is incorporated herein by reference in its entirety.

Acoustically effective facings may comprise an adhesive (e.g., a thermally activated adhesive). For example, some acoustically effective facings have an adhesive on one side thereof to allow for bonding to a thicker acoustic absorbing layer. Adhesive may be applied to acoustically effective facings by various means, including, but not limited to, screen printing, gravure coating, foam coating, die coating and scatter coating.

### SUMMARY OF THE INVENTION

The present application provides porous polymer coatings. Such porous polymeric coatings may impart useful adhesive and/or acoustic properties to a substrate. Furthermore, in some embodiments, the acoustic properties of such a composite material may be modulated by controlling the passage of air by the porous polymeric coating (e.g., by modulating the porosity of the porous polymeric coating). In some embodiments, the porous polymer coating comprises a polymeric foam having a void fraction of greater than about 15% and an air permeability greater than 3 cubic feet per minute per square foot as measured based on ASTM D737-04, wherein the polymeric foam comprises a clay and/or pigment optionally having an aspect ratio of about 2:1, 5:1, or 10:1 to about 20:1, 50:1, or 100:1. In some embodiments, the porous polymer coating comprises a chlorinated polymer and a fluorochemical.

The foregoing and other aspects of the present invention will now be described in more detail including other embodiments described herein.

### BRIEF DESCRIPTION OF THE DRAWINGS

FIG. 1 is an image of the surface of a porous polymer coating according to some embodiments of the present invention. The image was acquired using a scanning electron microscope.

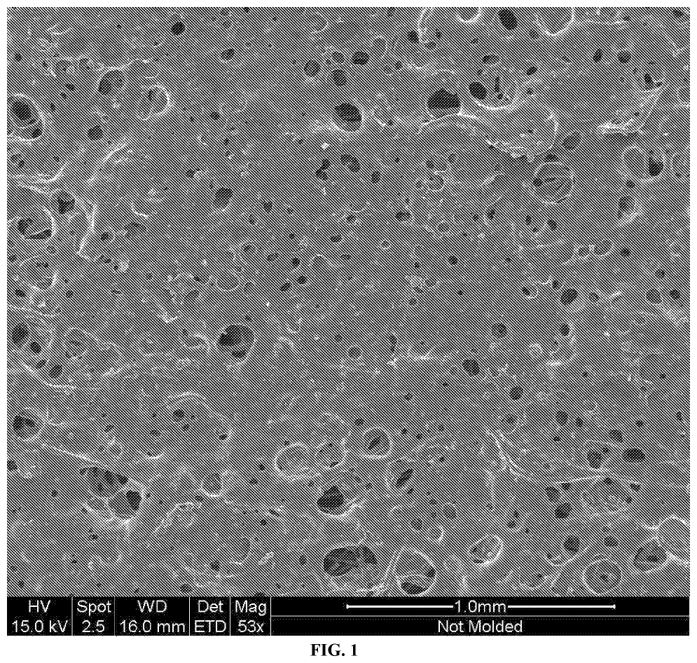

FIG. 2 is a cross-sectional image of the porous polymer coating depicted in FIG. 1. The image was acquired using a scanning electron microscope.

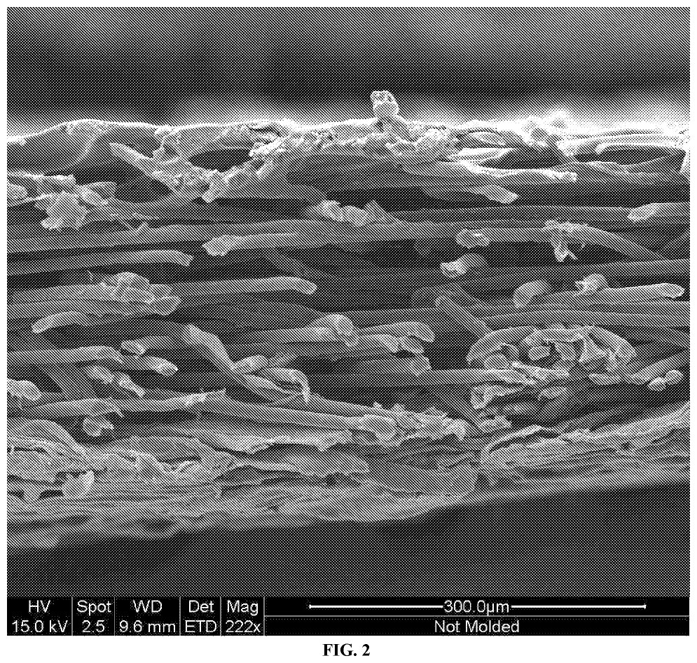

FIG. 3 is an image of the surface of a porous polymer coating according to some embodiments of the present invention. The sample was compressed prior to imaging. The image was acquired using a scanning electron microscope.

FIG. 4 is a cross-sectional image of the porous polymer coating depicted in FIG. 3. The image was acquired using a scanning electron microscope.

FIG. 5 is an image of the surface of a porous polymer coating according to some embodiments of the present invention. The sample was molded to and then removed from a web of fiberglass fibers prior to imaging. Residual glass fibers can be seen on the surface of the porous polymer coating. The image was acquired using a scanning electron microscope.

FIG. 6 is a cross-sectional image of the porous polymer coating depicted in FIG. 5. The image was acquired using a scanning electron microscope.

FIG. 7 is an image of the surface of a porous polymer coating according to some embodiments of the present invention. The image was acquired using a scanning electron microscope.

FIG. 8 is an image of the surface of a porous polymer coating according to some embodiments of the present invention. The image was acquired using a scanning electron microscope.

FIG. 9 is a graph comparing the air permeabilities of composite materials according to some embodiments of the present invention demonstrating that for a given formulation, fabric, and application system, the air permeability can be varied by varying the coating weight.

FIG. 10 is a graph similar to FIG. 9 comparing the air permeabilities of composite materials according to some embodiments of the present invention demonstrating that for a given formulation, fabric, and application system, the air permeability can be varied by varying the coating weight, such as by varying the foam applicator gap.

FIG. 11 is a graph showing variations of coating air permeability versus dry add-on weight resulting from compound formulation changes.

FIG. 12 is a graph comparing the dry add-on weights of porous polymer coatings in composite materials according to some embodiments of the present invention with the coating gaps used to form those composite materials.

FIG. 13 is a graph of air permeability versus add-on amount of porous polymer coatings including clay according to some embodiments of the present invention.

FIG. 14 is a graph showing regression for percent reduction in air permeability (which is the difference in air flow before and after bonding to simulate a manufacture's bonding process or “Delta Air Permeability” that is expressed as a percentage reduction from before bonding) versus clay solids (%) in porous polymer coatings according to some embodiments of the present invention.

FIG. 15 is an image of a surface of a coating of Formulation D showing the presence of cracks.

FIG. 16 is an image of a surface of a coating of Formulation E showing a smooth surface and the absence of cracks.

### DETAILED DESCRIPTION OF THE INVENTION

The present invention is explained in greater detail below. This description is not intended to be a detailed catalog of all the different ways in which the invention may be implemented or of all the features that may be added to the instant invention. For example, features illustrated with respect to one embodiment may be incorporated into other embodiments, and features illustrated with respect to a particular embodiment may be deleted from that embodiment. In addition, numerous variations and additions to the various embodiments suggested herein, which do not depart from the instant invention, will be apparent to those skilled in the art in light of the instant disclosure. Hence, the following specification is intended to illustrate some particular embodiments of the invention, and not to exhaustively specify all permutations, combinations and variations thereof.

It will be understood that when an element or layer is referred to as being “on”, “attached to”, “connected to”, “coupled to”, “coupled with” or “contacting” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. It will be appreciated by those of skill in the art that a structure referred to as being “directly on,” “directly connected to”, or “directly coupled to” another structure may partially or completely cover one or more surfaces of the other structure. It will also be appreciated by those of skill in the art that references to a structure or feature that is disposed “adjacent” another structure or feature may have portions that overlap or underlie the adjacent structure or feature.

The terminology used herein is for the purpose of describing particular embodiments only and is not intended to be limiting of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a complex comprises components A, B and C, it is specifically intended that any of A, B or C, or a combination thereof, can be omitted and disclaimed.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, +1%, ±0.5%, or even ±0.1% of X. A range provided herein for a measureable value may include any other range and/or individual value therein.

As used herein, “ASTM” refers to ASTM, International, 100 Barr Harbor Drive, P.O. Box C700, West Conschoken, Pa. 19428-2959 USA.

As used herein, the term “air permeability” refers to the rate of air flow passing perpendicularly through a known area of a material under a prescribed air pressure differential. See, e.g., ASTM Standard D737-04, “Standard Test Method for Air Permeability of Textile Fabrics,” ASTM International (2012) of 0.5 inches of water column pressure drop. Unless otherwise specified, the air permeability measurements described herein are expressed in cubic feet per minute per square foot (hereinafter “cfm”).

As used herein, the term “airflow resistance” refers to the impedence of airflow through a known area of a material under a prescribed air pressure differential. See, e.g., ASTM Standard C522-03, “Standard Test Method for Airflow Resistance of Acoustical Materials,” ASTM International (2009). Unless otherwise specified, the airflow resistance measurements described herein were measured based on ASTM Standard C522-03, “Standard Test Method for Airflow Resistance of Acoustical Materials,” ASTM International (2009). Unless otherwise specified, the air permeability measurements described herein are expressed in Rayls. Air permeability and airflow resistance are reflective of expected acoustic impedance.

As used herein, the term “batt” refers to a sheet or web of unbounded or lightly bonded fibers.

As used herein, the term “blow ratio” refers to the ratio of air to liquid in a porous material (e.g., a foam). For example, if a known volume of liquid has a weight of 20 grams, and air is introduced into the liquid such that an equal volume of the foamed liquid has a weight of 2 grams, the blow ratio of the foamed liquid is 10 (i.e., the foamed liquid has an air to liquid ratio of 10:1).

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of greater than about 20% or more. For example, a component added to a composition of the present invention would “materially alter” the composition if it increases or decreases the composition's durability by greater than 20%.

As used herein, the terms “increase” and “enhance” (and grammatical variants thereof) refer to an increase in the specified parameter of greater than about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more.

As used herein, the terms “inhibit”, “decrease”, and “reduce” (and grammatical variants thereof) refer to a decrease in the specified parameter of greater than about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 99% or more.

As used herein, the term “latex” refers to an aqueous dispersion/emulsion of one or more polymers.

As used herein, the term “porous polymer coating” refers to a porous, polymeric structure that controls the passage of air.

As used herein, the term “Rayl” refers to specific acoustic impedance and/or characteristic acoustic impedance of an article. As one skilled in the art will readily appreciate, the acoustic impedance may be defined as one or two units: an MKS unit and a CGS unit. In MKS units, 1 Rayl equals 1 pascal-second per meter (Pa·s·m⁻¹). In CGS unites, 1 Rayl equals 1 dyne-second per cubic centimeter (dyn·s·cm⁻³). 1 CGS Rayl=10 MKS Rayls. Unless otherwise specified, the Rayls measurements described herein are expressed in MKS units.

As used herein, the term “reticulated foam” refers to a foam wherein the majority of the bubbles/cells are not fully intact. In some embodiments, about 1%, 5%, 10%, 15%, 20%, 25%, 30%, 35%, 45%, 50%, 55% 60%, 65%, 70%, 75%, 80%, 85%, 90%, 95%, 96%, 97%, 98%, 99% or 100% of the bubbles/cells within the reticulated foam are open bubbles/cells. In some embodiments, the bubbles/cells are open to the extent that only the common/shared boundaries of the bubbles/cells remain intact.

As used herein, the term “thermally activatable” refers to a material that adhesively bonds when heated. In some embodiments, thermally activatable as used herein refers to heat sealing a porous polymer coating of the present invention to a material. Heat sealing of the coating to a material may occur when the coating and material are held together for a given period of time and are heated, or when the coating is heated and subsequently brought into contact with the material. In some embodiments, a porous polymer coating of the present invention is thermally activatable when exposed to a temperature of about 260° F., 300° F., or 350° F. to about 400° F. or 500° F. for optionally about 30 seconds to about 1, 2, or 3 minutes.

All publications, patent applications, patents, and other references mentioned herein are incorporated by reference in their entirety.

Porous polymer coatings of the present invention may comprise any suitable polymer, including, but not limited to, thermoplastic polymers and/or non-thermoplastic polymers. In some embodiments, porous polymer coatings of the present invention comprise, consist essentially of or consist of one or more thermoplastic polymers and/or one or more non-thermoplastic polymers. In some embodiments, porous polymer coatings of the present invention comprise, consist essentially of or consist of one or more thermoset polymers. In some embodiments, porous polymer coatings of the present invention comprise, consist essentially of or consist of one or more water soluble polymers. In some embodiments, porous polymer coatings of the present invention comprise, consist essentially of or consist of one or more polymers derived from an emulsion or a dispersion (e.g., one or more polymer layers derived from an emulsion or dispersion). In some embodiments, porous polymer coatings of the present invention comprise, consist essentially of or consist of one or more melted and extruded polymers. In some embodiments, porous polymer coatings of the present invention comprise, consist essentially of or consist of one or more copolymers and/or one or more polymer blends. In some embodiments, porous polymer coatings of the present invention comprise, consist essentially of or consist of one or more latex binders. Polymers and/or polymer dispersions present in a porous polymer coating of the present invention may be used as a binder.

Porous polymer coatings of the present invention may comprise any suitable thermoplastic polymer, including, but not limited to, polyacrylates, polyvinylacetates, styrene butadiene rubbers, diallylorthophthalates, ionomers, formulated epoxys, polysulfones, perfluorinated polymers and elastomers, polyether-etherketones, acrylonitrilebutadienstyrenes, polycarbonates, vinylesters, styrene copolymers, polyamides, polyamines, ethylenevinylacetates, polyvinyalcohols, polyvinylchlorides, polyvinylidiene chloride, chlorinated polyethylenes, polyesters, nitriles, polyurethanes, polyethylenes, polypropylenes. In some embodiments, porous polymer coatings of the present invention comprise, consist essentially of or consist of one or more thermoplastic copolymers and/or one or more thermoplastic polymer blends. In some embodiments, the porous polymer coatings of the present invention comprise one or more acrylic thermoplastic polymers and one or more copolyester thermoset polymers.

In some embodiments, a porous polymer coating of the present invention comprises a chlorine containing polymer (i.e., a chlorinated polymer) and/or a chlorine containing polymer dispersion (i.e., a chlorinated polymer dispersion). In some embodiments, a porous polymer coating of the present invention comprises ethylene-vinyl chloride (EVCL), vinyl chloride ethylene vinyl ester acrylate terpolymer, ethylene-vinyl chloride vinyl acetate, polyvinylidene chloride (PVDC), and/or polyvinyl chloride acrylic copolymer. In some embodiments, a porous polymer coating of the present invention comprises a polymer dispersion. Example polymer dispersions include, but are not limited to, polymer dispersions including ethylene-vinyl chloride (EVCL) such as, e.g., those under the tradename VINNOL® 4514 commercially available from Wacker Chemie AG, polymer dispersions including vinyl chloride ethylene vinyl ester acrylate terpolymer, such as, e.g., those under the tradename VINNAPAS® CEF 52 commercially available from Wacker Chemie AG, polymer dispersions including ethylene-vinyl chloride vinyl acetate, polymer dispersions including polyvinylidene chloride (PVDC), and/or polymer dispersions including polyvinyl chloride acrylic copolymer.

A polymer and/or polymer dispersion may be present in a porous polymer coating in an amount of about 1%, 5%, 10%, 15%, 20%, or 25% to about 30%, 35%, 40%, 45%, 50%, 55%, 60%, 65%, 70%, 75%, 80%, 85%, or 90% by weight (wet) of the coating. In some embodiments, the polymer and/or polymer dispersion has a glass transition temperature in a range of about −10 to about +35 or about +10 to about +14. In some embodiments, the polymer and/or polymer dispersion has a glass transition temperature of about −10, −9, −8, −7, −6, −5, −4, −3, −2, −1, 0, +1, +2, +3, +4, +5, +6, +7, +8, +9, +10, +11, +12, +13, +14, +15, +16, +17, +18, +19, +20, +21, +22, +23, +24, +25, +26, +27, +28, +29, +30, +31, +32, +33, +34, or +35.

In some embodiments, a polymer present in a porous polymer coating of the present invention has flame retardant properties. In some embodiments, a porous polymer coating of the present invention may not include (i.e., is devoid of) a traditional flame retardant (e.g., ammonium polyphosphate (APP) or phosphate esters) and may optionally include a polymer with flame retardant properties. In some embodiments, a traditional flame retardant (e.g., ammonium polyphosphate (APP) or phosphate esters) may plasticize polymers present in a porous polymer coating, lead to blocking issues, and/or negatively affect the water repellency of a porous polymer coating prepared from such a composition.

A porous polymer coating of the present invention may comprise a polymer having a chlorine content in a range of about 10%, 11%, 12%, 13%, 14%, 15%, 16%, 17%, 18%, 19%, 20%, 21%, 22%, 23%, 24%, or 25% to about 50%, 51%, 52%, 53%, 54%, 55%, 56%, 57%, 58%, 59%, 60%, 61%, 62%, 63%, 64%, or 65%. In some embodiments, a porous polymer coating of the present invention comprises a polymer having a chlorine content of about 10%, 15%, 20%, 25%, 30%, 35%, 40%, 45%, 50%, 55%, 60%, 65%, or 70%. In some embodiments, a porous polymer coating of the present invention passes industry flame tests such as, e.g., MVSS 302, UL94 VTM-0, etc. The chlorine content of polymers in a coating of the present invention optionally along with an inexpensive condensed phase flame retardant (e.g., aluminum trihydrate, ATH), may provide adequate flame response to pass industry flame tests such as MVSS 302. In some embodiments, a porous polymer coating of the present invention, optionally when coated onto a substrate, and/or a composite of the present invention passes MVSS 302.

A porous polymer coating of the present invention may be prepared from an emulsion (e.g., an oil-in-water or water-in-oil emulsion). In some embodiments, a polymer dispersion present in a coating of the present invention is an emulsion. In some embodiments, an emulsion (e.g., a polymer dispersion present in a coating and/or a coating) of the present invention may have a small particle size (e.g., about 0.12 microns or less), which may be beneficial in creating a more hydrophobic and/or abrasion resistant film surface on the coating. In some embodiments, a surface of a coating of the present invention may be sufficiently hydrophobic to pass water drop test GMS16522 3.1.6 for about one to three hours (e.g., for about 1, 2, or 3 hours). In some embodiments, a coating of the present invention is provided on a first surface of a fabric and the coating enhances the hydrophobicity of the fabric such that the opposing surface of the fabric (i.e., the side which the coating was not applied to) can pass water drop test GMS16522 3.1.6 for about one to three hours (e.g., for about 1, 2, or 3 hours). In some embodiments, a coating of the present invention may have an abrasion resistance such that weight-loss from a fabric comprising the coating, when tested with the coated side, is less than about 2 mg (e.g., less than about 1.5, 1, or 0.5 mg, or is 0 mg), whereas the same fabric, uncoated, may have a weight-loss of greater than 90 mg (e.g., 95 or 100 mg, or more), when tested using test method ASTM Standard D4966-12. In some embodiments, a coating of the present invention may have an abrasion resistance such that weight-loss from a fabric comprising the coating, when tested with the non-coated side, is less than about 10 mg (e.g., less than about 9, 8, 7, 6, 5, 4, 3, 2, or 1 mg, or is 0 mg), whereas the same fabric, uncoated, may have a weight-loss of greater than 90 mg (e.g., 95 or 100 mg, or more), when tested using test method ASTM Standard D4966-12. A coating of the present invention may reduce or eliminate fiber loss and/or coating loss, when exposed to abrasion on the coated side of a fabric, and may significantly reduced fiber loss on the non-coated side as compared to greige fabric.

In some embodiments, a polymer present in a porous polymer coating of the present invention is thermally activatable, which may aid in providing the coating with excellent bond strength such as, e.g., for molding applications. In some embodiments, a porous polymer coating of the present invention, when tested with a stacked sample as described herein, may have a bond strength, optionally as measured in accordance with AATTC Standard 136, “Bond Strength of Bonded and Laminated Fabrics,” American Association of Textile Chemists and Colorists, (2012), of at least about 150 grams/inch or more (e.g., about 175, 200, 250, or 300 g/inch or more) or that is destructive to the substrate to which the coating is bound.

Porous polymer coatings of the present invention may comprise an additive, including, but not limited to, porogenic agents, adhesive agents, blowing agents, foaming agents, stabilizing agents (e.g., foam stabilizers, thermal stabilizers, light stabilizers, etc.), lubricating agents, tackifying agents, slip agents, elastic agents, antistatic agents, electrically conductive agents, antimicrobial agents (e.g., antibacterial agents, mildewcides, etc.), antifungal agents, coloring agents (e.g., pigments), repellant agents (e.g., water repellants, alcohol repellants, oil repellants, soil repellants, stain repellants, etc), flame retardant agents, UV resistant agents, UV absorption agents and filler agents, such as clay, calcium carbonate, minerals, polymer or mineral (e.g., glass) beads, metallic fillers, and the like. In some embodiments, porous polymer coatings of the present invention comprise one or more active agents. In some embodiments, porous polymer coatings of the present invention comprise one or more agents that increase the durability of the porous polymer coating (and/or a substrate to which the porous polymer coating is applied). For example, the porous polymer coating may comprise one or more isocyanates (e.g., blocked ioscyanates). In some embodiments, porous polymer coatings of the present invention comprise one or more flame retardant chemistries or additives. For example, the porous polymer coating may comprise one or more flame retardant antimony compounds (e.g., antimony oxides), one or more flame retardant boron compounds (e.g., ammonium borate, borax, boric acid, ethanolammonium borate and/or zinc borate), one or more flame retardant halogen compounds (e.g., ammonium bromide, ammonium chloride, brominated/chlorinated binders, brominated/chlorinated additives and/or brominated/chlorinated paraffin), one or more flame retardant nitrogen compounds (e.g., monoammonium phosphate, diammonium phosphate, ammonium borate, ammonium bromide, ammonium chloride, ammonium polyphosphate, melamine, melamine cyanurate, and/or urea), organic and inorganic containing compounds, phosphorous containing compounds (e.g. ammonium polyphosphate), one or more flame retardant sulfur compounds (e.g., ammonium sulfamate), and/or one or more condensed-phase flame retardants (such as, e.g., alumina trihydrate magnesium hydroxide or calcium carbonate). In some embodiments, porous polymer coatings of the present invention comprise one or more antistats. For example, the porous polymer coating may comprise one or more salts, sodium chloride, sodium nitrate, sodium sulfate, or phosphate esters and/or one or more quaternary ammonium compounds.

In some embodiments, a porous polymer coating of the present invention comprises a clay (e.g., hydrated silica-aluminate or kaolin) and/or a pigment having an aspect ratio (i.e., a ratio of width:height) in a range of about 2:1 to about 100:1 such as, for example, in a range of about 2:1 to about 20:1, about 5:1 to about 50:1, about 8:1 to about 15:1, or 5:1 to about 20:1. In some embodiments, the clay and/or a pigment has an aspect ratio of about 2:1, 5:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, or 100:1. In some embodiments, the clay and/or a pigment has an aspect ratio of about 10:1. In some embodiments, a porous polymer coating of the present invention comprises calcined clay, delaminated clay, and/or high-aspect ratio clay. Example clays include, but are not limited to, those such as Kaopaque 10S (10-40:1 Aspect Ratio) and “Hyper Platy” kaolins such as Imerys Hydrite® SB60 (60:1 Aspect Ratio) and Imerys Hydrite® SB100 Aspect Ratio 100:1, each commercially available from Imerys Kaolin.

The clay and/or a pigment may have a particle size in a range of about 0.001 μm to about 100 μm such as, for example, in a range of about 0.001 μm to about 50 μm, about 0.01 μm to about 10 μm, about 0.1 μm to about 20 μm, about 0.1 μm to about 5μm, or about 1 μm to about 75 μm. In some embodiments, the clay and/or a pigment has a particle size of about 0.001, 0.005, 0.01, 0.05, 0.1, 0.5, 1, 5, 10, 15, 20, 25, 30, 35, 40, 45, 50, 55, 60, 65, 70, 75, 80, 85, 90, 95, or 100 μm. In some embodiments, the clay and/or a pigment has a particle size of about 1 μm.

The clay and/or a pigment may have a whiteness (as quantified by L value using Technical Association of the Pulp and Paper Industry (TAPPI) Test Method T 560 entitled “CIE whiteness and tint of paper and paperboard (d/0 geometry, C/2 illuminant /observer), Test Method T 560 om-10”) in a range of about 70 to about 100 such as, for example, in a range of about 80 to about 100 or about 90 to about 100. In some embodiments, the clay and/or a pigment has a whiteness (as quantified by L value using TAPPI Test Method T 560) of about 70, 75, 80, 85, 90, 95, or 100. In some embodiments, the clay and/or a pigment has a whiteness (as quantified by L value using TAPPI Test Method T 560) of about 95.

The clay and/or a pigment may have a brightness (as quantified using TAPPI Test Method T 452 entitled “Brightness of pulp, paper, and paperboard (directional reflectance at 457 nm), Test Method T 452 om-08”) in a range of about 70 to about 100 such as, for example, in a range of about 80 to about 100 or about 90 to about 100. In some embodiments, the clay and/or a pigment has a brightness (as quantified using TAPPI Test Method T 452) of about 70, 75, 80, 85, 90, 95, or 100. In some embodiments, the clay and/or a pigment has a brightness (as quantified using TAPPI Test Method T 452) of about 89.

The clay and/or a pigment may have a hardness (quantified in accordance with the Mohs Hardness Test and Scale) in a range of about 2 to about 5 such as, for example, in a range of about 2 to about 4 or about 2 to about 3. In some embodiments, the clay and/or a pigment has a hardness (quantified in accordance with the Mohs Hardness Test and Scale) of about 2, 3, 4, or 5. In some embodiments, the clay and/or a pigment has a hardness (quantified in accordance with the Mohs Hardness Test and Scale) of about 3.

The clay and/or a pigment may have a mean refractive index in a range of about 1.50 to about 1.60. In some embodiments, the clay and/or a pigment has a mean refractive index of about 1.50, 1.51, 1.52, 1.53, 1.54, 1.55, 1.56, 1.57, 1.58, 1.59, or 1.60. In some embodiments, the clay and/or a pigment has a mean refractive index of about 1.56.

The clay and/or a pigment may be present in a porous polymer coating of the present invention in an amount of about 1% to about 40% by weight (dry) of the final coating solids such as, for example, about 1% to about 20%, about 2% to about 30%, or about 2% to about 10% by weight (dry) of the final coating solids. In some embodiments, the clay and/or a pigment is present in the porous polymer coating in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, or 40% by weight (dry) of the final coating solids. “Dry final coating solids weight”, “dry weight”, or “weight (dry) of the final coating solids” as used herein refer interchangeably to the dry weight of the final coating and/or a component thereof. The dry weight may be obtained by applying a wet porous polymer coating formulation of the present invention onto a substrate and drying the formulation to about 0% moisture such as, e.g., on production equipment. In some embodiments, the dry weight is obtained by a measurement of percent solids by placing 1 gram of a wet porous polymer coating formulation of the present invention in an aluminum weigh pan, weighing the formulation (i.e., the first weight measurement), drying the formulation at 105° F. for 30 minutes to obtain a dried formulation, allowing the dried formulation to cool to room temperature in a desiccator (about one hour), and weighing the dried formulation (i.e., the second weight measurement) to thereby obtain the percent solids, which is calculated by taking the second weight measurement divided by the first weight measurement. When the dry weight is used in reference to the amount of a component (e.g., clay) present in the dry coating, the dry weight of the component is the weight portion of the component in the dry coating. For example, in a formulation having clay present in an amount of 40% by weight (dry) of the final coating solids (also referred to as by dry weight of the final solids content of the polymeric foam or coating), when there are 100 grams of the dried coating, then 40 grams of clay would be present in the dried coating. When the percent by weight (wet) of a component is referred to herein it refers to the weight of the component in a wet porous polymer coating formulation (i.e., a formulation that has not been dried) such as, e.g., the porous polymer coating formulation upon initial combination of all components for the formulation and prior to drying.

In some embodiments, a porous polymer coating of the present invention may be used to impart a specific air permeability and/or acoustic property to a substrate such as, e.g., fabrics used in various applications including, but not limited to, application in automotive, aerospace, engine compartment, carpet, headliner, etc. The coating may be in contact with and/or be applied to the substrate to provide a composite (also referred to herein as a composite material). For example, the coating may be in contact with and/or be applied to a nonwoven fabric (e.g., a flame retardant, water resistant, and/or high elongation nonwoven fabric) and may impart air flow resistance properties consistent with acoustic performance (as measured in “rayls”). In some embodiments, a porous polymer coating of the present invention may function as an adhesive allowing a substrate (e.g., a fabric) to be attached to another material such as, but not limited to, fiber glass batting, polyethylene terephthalate (PET) batting, foam, carpet, etc., and may also maintain air flow resistance, thereby imparting acoustical absorption. In some embodiments, a porous polymer coating of the present invention may be in contact with and/or applied to any air permeable surface to impart appropriate air flow resistance to achieve the acoustic performance, optionally without a fabric substrate. Thus, in some embodiments, a porous polymer coating of the present invention may not be in contact with and/or applied to a fabric.

It was unexpectedly discovered that by incorporating a clay and/or pigment as described herein can provide a porous polymer coating of the present invention with improved stability of air flow resistance and/or air permeability. In some embodiments, a porous polymer coating of the present invention may have improved stability of air flow resistance and/or air permeability upon exposure of the coating to certain conditions and/or processes such as, e.g., during transport and/or storage in a supply chain, in a subsequent manufacturing process, and/or after exposure to high temperature and/or pressure. In some embodiments, “high temperature” refers to a temperature of about 180° F. or greater such as, for example, from about 180° F. to about 200° F., 300° F., or 400° F. In some embodiments, “high pressure” refers to a pressure of about 5 pounds per square inch (psi) or greater such as, for example, from about 5, 10, 15, 20, 25, or 30 psi. In some embodiments, a porous polymer coating of the present invention may have improved stability of air flow resistance and/or air permeability upon exposure of the coating to certain conditions and/or processes by maintaining the air flow resistance and/or air permeability of the coating after exposure to the certain conditions and/or processes within ±25% (e.g., within ±25%, +20%, ±15%, ±10%, ±5%, or less) of the air flow resistance and/or air permeability of the coating prior to the exposure to certain conditions and/or processes. In some embodiments, a composite material comprising a porous polymer coating of the present invention that is in contact with and/or adhered to a fabric may have improved stability of air flow resistance and/or air permeability upon exposure of the composite material to certain conditions and/or processes by maintaining the air flow resistance and/or air permeability of the composite material after exposure to the certain conditions and/or processes within ±25% of the air flow resistance and/or air permeability of the composite material prior to the exposure to certain conditions and/or processes. In some embodiments, a porous polymer coating of the present invention has an air flow resistance and/or air permeability prior to bonding to a substrate (e.g., a fabric) that is within ±25% (e.g., within ±25%, ±20%, ±15%, ±10%, ±5%, or less) of the air flow resistance and/or air permeability of the coating after bonding to the substrate (e.g., post-bonding). The pre-bonding air flow resistance and/or air permeability for a coating of the present invention may be measured with a porous polymer coating dried on a first substrate (e.g., a fabric sample) to provide a composite that is stacked (like sandwich) with the coating side of the composite facing and contacting (but not bonded to) a second substrate (e.g., a 3.7 osy PET needle-punch fabric), which may be referred to herein as a stacked sample or pre-bonded sample. Bonding of the stacked sample may be achieved at a temperature of about 180° F. or greater (e.g., from about 180° F. to about 200° F., 300° F., or 400° F.) and/or pressure of about 5 pounds per square inch (psi) or greater (e.g., from about 5, 10, 15, 20, 25, or 30 psi) to provide a bonded sample in which the coating is adhered to a surface of the second substrate. In some embodiments, bonding of a stacked sample may be achieved at a temperature of about 380° F. for 1 minute at a set gap of 0.05 inches (resulting in less than 10 psi pressure) to provide a bonded sample. The change in air permeability, or “Delta Air Permeability”, is the difference between these two measurements (i.e., the pre-bonded and post-bonded measurements). Current coating technologies frequently have air resistances or air permeabilities that change significantly upon exposure to high temperatures and/or pressures. This is often encountered in the fabrication of an acoustic article where part-molding or attachment processes include elevated temperatures and pressures in a roll nip or part mold. Elevated temperatures can also be encountered in the supply chain (e.g., warehouse or truck trailer without environmental control).

In some embodiments, a porous polymer coating of the present invention obviates “hold-out properties” (i.e., properties that hold a flowable coating on a surface of a substrate (e.g., a fabric)) of the base substrate (e.g., a fabric). This may allow for a wider variety of base substrates (e.g., base fabrics) and/or allow for the elimination of a finishing step prior to coating the base substrate, which reduces cost and waste and can provide a more stable acoustical product. In some embodiments, a porous polymer coating of the present invention passes a 1 hour and/or 3 hour water drop hold out test in accordance with GMW-16522 3.1.6. In some embodiments, the hold-out properties of a coating are tested on a substrate (e.g., fabric) that is not treated or finished with a fluorochemical and/or flame retardant.

In some embodiments, a porous polymer coating of the present invention may comprise one or more (e.g., 1, 2, 3, 4, 5, or more) surfactants. In some embodiments, one or more surfactants are present in an amount of about 0.01% to about 30% by weight (wet) of the coating such as, for example, about 0.01% to about 10%, about 0.1% to about 8%, about 0.1% to about 2%, or about 0.5% to about 5%, or about 20% to about 30% by weight (wet) of the coating. In some embodiments, a porous polymer coating of the present invention comprises one or more surfactants with each surfactant being present in an amount of about 0.01% to about 10% by weight (wet) of the coating. Example surfactants include those known to those of skill in the art such as, but are not limited to, ammonium stearate, ammonium lauryl sulfate, N-octyl-sulfosuccinamate, amine oxide, phosphate esters, succinamates, alcohol sulfates, betaines, and dispersants, such as, e.g., polyacrylate dispersants. In some embodiments, the surfactant is an amphoteric surfactant.

Water may be present in a porous polymer coating of the present invention in an amount of about 25%, 30%, 35%, or 40% to about 45%, 50%, 55%, 60%, 65%, 70%, 75%, 80%, 85%, or 90% by weight (wet) of the coating. One or more clays and/or pigments may be present in a porous polymer coating of the present invention in an amount of about 0.5%, 1%, 2%, 3%, 4%, 5%, 6%, 7%, 8%, or 9% to about 10%, 20%, 30%, 40%, 50%, 60%, or 70% by weight (wet) of the coating. One or more inert functional pigments and/or flame retardants (e.g., non-halogen flame retardants) may be present in a porous polymer coating of the present invention in an amount of about 0%, 0.25%, 0.5%, 1%, 2%, 3%, 4%, or 5% to about 10%, 20%, 30%, 40%, 50%, 60%, or 70% by weight (wet) of the coating. One or more polymers and/or polymer dispersions may be present in a porous polymer coating of the present invention in an amount of about 2%, 5%, 10%, 15%, 20%, 25%, 30%, or 35% to about 40%, 45%, 50%, 55%, 60%, 65%, 70%, 80%, 85%, or 90% by weight (wet) of the coating. One or more pH adjusting agents (e.g., a base or acid) may be present in a porous polymer coating of the present invention in an amount of about 0% to about 2% by weight (wet) of the coating. One or more thickening agents may be present in a porous polymer coating of the present invention in an amount of about 0%, 0.1%, 0.25%, 0.5%, 0.75%, or 1% to about 1.5%, 2%, 2.5%, or 3% by weight (wet) of the coating. Example thickening agents include, but are not limited to, alkali swellable thickeners, associative thickeners, hydrophobically modified thickeners, cellulosic thickeners (e.g., hydroxpropyl cellulose), sugar based thickeners, gum based thickeners, protein based thickeners, and/or starch based thickeners. One or more biocides may be present in a porous polymer coating of the present invention in an amount of about 0%, 0.01%, or 0.05% to about 0.1%, 0.25%, 0.5%, 1%, 1.5%, or 2% by weight (wet) of the coating. One or more fluorochemicals may be present in a porous polymer coating of the present invention in an amount of about 0%, 0.1%, 0.25%, 0.5%, 0.75%, 1%, 1.5%, 2%, or 2.5% to about 3%, 3.5%, 4%, 4.5%, 5%, 5.5%, 6%, 6.5%, 7%, 7.5%, 8%, 8.5%, 9%, 9.5%, or 10% by weight (wet) of the coating.

A fluorochemical as used herein refers to an organic compound including at least one fluorine atom that is attached or bonded to a carbon atom. In some embodiments, a fluorochemical is a fluoropolymer. Example fluorochemicals include, but are not limited to, acrylic based fluorochemicals and/or fluoropolymers, urethane based fluorochemicals and/or fluoropolymers, epoxy based fluorochemicals and/or fluoropolymers, silicon based fluorochemicals and/or fluoropolymers, hybrid fluoropolymers, and/or combinations thereof. Further example fluorochemicals include, but are not limited to, fluoropolymers (e.g., C-6 fluoropolymers); fluorotelomers (e.g., C-6 fluortelomers); fluorine containing compounds under the trandename NUVA® such as, e.g., NUVA® 2155, commercially available from Archroma; fluoroalkyl acrylate copolymers such as, e.g., those under the tradename UNIDYNE™ such as, e.g., UNIDYNE™ TG-5502 and UNIDYNE™ TG-5506, available from Daikin Industries, Ltd.; and fluorine containing compounds under the tradename AsahiGuard E-SERIES™ such as, e.g., AG-E100, available from AGC Chemicals. In some embodiments, a fluorochemical in a coating of the present invention is a film-forming, partially-fluorinated acrylic copolymer (e.g., present in a water based, film-forming, partially-fluorinated acrylic copolymer emulsion) and/or a fluoroalkyl acrylate copolymer (e.g., present in a fluoroalkyl acrylate copolymer emulsion). In some embodiments, a fluorochemical in a coating of the present invention is a C-6 fluorine containing compound such as, for example, a C-6 fluorinated (e.g., partially fluorinated) acrylic copolymer and/or a C-6 fluoroalkyl acrylate copolymer.

One or more coloring agents may be present in a porous polymer coating of the present invention in an amount of about 0%, 0.1%, 0.25%, 0.5%, or 0.75% to about 1%, 1.5%, 2%, 2.5%, 3%, 3.5%, 4%, 4.5%, or 5% by weight (wet) of the coating. In some embodiments, a blow ratio (i.e., the ratio of air to coating fluid volume) for the porous polymer coating is about 1:1 to about 20:1 and, in some embodiments, about 5:1. In some embodiments, the blow ratio is about 1:1, 2:1, 3:1, 4:1, 5:1, 6:1, 7:1, 8:1, 9:1, 10:1, 11:1, 12:1, 13:1, 14:1, 15:1, 16:1, 17:1, 18:1, 19:1, or 20:1.

Exemplary porous polymer coatings are described below in Table 1.

TABLE 1
Exemplary Porous Polymer Coatings.

| | Formula- | Formula- | Formula- | Example |
|---|---|---|---|---|
| | tion A | tion B | tion C | Range |
| | (% by | (% by | (% by | (% by |
| | weight, | weight, | weight, | weight, |
| Components | wet) | wet) | wet) | wet) |
| Water | 35.35% | 36.35% | 35.35% | 25-90% |
| Dispersant Surfactant | 0.5% | 0.5% | 0.5% | 0-8% |
| (may be used to | | | | |
| disperse clay into | | | | |
| slurry) | | | | |
| Kaolin Clay | 8.75% | 3.0% | 0 | 0.5-70% |
| (Aspect Ratio >5:1) | | | | |
| (Barrier/Filler, may | | | | |
| control air flow volume | | | | |
| for acoustic properties | | | | |
| also for air flow | | | | |
| stability) | | | | |
| Alumina Trihydrate | 8.75% | 14.5% | 17.5% | 0-70% |
| (ATH) | | | | |
| (Non-Halogen Flame | | | | |
| Retardant/Inert | | | | |
| functional pigment that | | | | |
| may release water | | | | |
| molecules at elevated | | | | |
| temperature (e.g. at | | | | |
| 220° C. or more) in an | | | | |
| endothermic reaction) | | | | |
| PVC Emulsion (+10 | 39% | 39% | 39% | 2-90% |
| to +14 Tg) | | | | |
| (Thermoplastic binder | | | | |
| that may be used for | | | | |
| film formation/ | | | | |
| adhesion/flame | | | | |
| retardancy) | | | | |
| Ammonium Stearate | 1.5% | 1.5% | 1.5% | 0.1-10% |
| (Surfactant, Foaming | | | | |
| Agent/may refine | | | | |
| and/or stabilize foam | | | | |
| structure) | | | | |
| N-Octl- | 1.75% | 1.75% | 1.75% | 0.1-10% |
| Sulfosuccinamate | | | | |
| (Surfactant, Foaming | | | | |
| Agent. | | | | |
| Amount/loading of this | | | | |
| surfactant may be | | | | |
| adjusted to achieve the | | | | |
| appropriate Blow | | | | |
| Ratio. For example, | | | | |
| with a loading of | | | | |
| 1.75%, the Blow Radio | | | | |
| may be in a range of | | | | |
| 1:1-20:1) | | | | |
| Ammonium | 0.5% | 0.5% | 0.5% | 0-2% |
| Hydroxide | | | | |
| (may be used to adjust | | | | |
| compound pH and/or | | | | |
| activate alkali | | | | |
| swellable thickener) | | | | |
| Alkali Swellable | 1.3% | 1.3% | 1.3% | 0.1-3% |
| Thickener | | | | |
| (Viscosity Modifier. | | | | |
| Increased viscosity | | | | |
| may be needed to place | | | | |
| the foam at the surface | | | | |
| of the substrate during | | | | |
| application process, | | | | |
| creating a continuous | | | | |
| film layer that may | | | | |
| reduce air | | | | |
| permeability.) | | | | |
| Biocide | 0.1% | 0.1% | 0.1% | 0.01-2% |
| (may control mold | | | | |
| grown in tote) | | | | |
| Fluorochemical | 2.0% | 1.0% | 2.0% | 0.1-10% |
| (may provide water | | | | |
| repellency properties) | | | | |
| Carbon Black | 0.5% | 0.5% | 0.5% | 0-5% |
| Pigment | | | | |
| (Optional coloring | | | | |
| agent) | | | | |

In some embodiments, Formulation A may be used with an untreated greige fabric. Formulation A with its higher Koalin Clay content than Formulation B or C may be used on a porous, unfinished, easily penetrated fabrics since the clay pigment may provide more air flow resistance (less permeability) per add-on unit. In some embodiments, Formulation B may be used with a material that is pretreated in an initial finishing process step. Formulation B contains less clay than Formulation A, but more ATH (alternative pigment), which may make it better for a less porous, finished fabric (finish is generally done for other properties such as water resistance, flame resistance etc. that can also provide coating hold out on the surface).

Further exemplary porous polymer coatings are described below in Table 2. The air permeability and airflow resistance of the porous polymer coatings can be modulated by adjusting porosity thereof (e.g., by adjusting the blow ratio, drying conditions and/or chemical additives used during formation).

TABLE 2
Further Exemplary Porous Polymer Coatings.

| | | Formula | Formula | Formula | Formula |
|---|---|---|---|---|---|
| | | 1 | 2 | 3 | 4 |
| Ingredient | Description | (grams) | (grams) | (grams) | (grams) |
| Water | Carrier medium | 75 | | | 160 |
| Binder | Polymer | 196 | | | |
| | dispersion | | | | |
| | or emulsion | | | | |
| Flovan | Phosphate based | | | 70 | 40 |
| CGN | flame retardant | | | | |
| Exolit 462 | Phase 2 APP | 24 | | | |
| | encapsulated with | | | | |
| | melamine | | | | |
| Unifroth | Anionic foaming | 2.5 | | | |
| 144 | agent | | | | |
| Stanfax 320 | Ammonium | 2.5 | 6 | 12 | 12 |
| | stearate | | | | |
| Synthebond | Styrene acrylate | | 200 | 154 | 90 |
| SA 110 | copolymer | | | | |
| | dispersion | | | | |
| Fuller PN- | Styrene acrylate | | 100 | | |
| 3691-M | copolymer | | | | |
| | emulsion | | | | |
| Synthebond | Styrene acrylate | | | 154 | 90 |
| SA103 | copolymer | | | | |
| | dispersion | | | | |
| Ammonyx | Lauramine oxide | | 6 | 8 | 8 |
| LO | | | | | |
| Aqueous | Base for pH | | | 2 | 2 |
| Ammonium | adjustment | | | | |
| Hydroxide | | | | | |

Porous polymer coatings of the present invention may be formed using a method, composition, and/or apparatus suitable for introducing air into a polymer dispersion or emulsion, including, but not limited to, blowing agents, foaming agents, volatile liquids, commercial mixers (e.g., Hobart® (Troy, Ohio) mixers, KitchenAid® (St. Joseph, Mich.) mixers, etc.) and commercial foam generator systems (e.g., the CFS® System by Gaston Systems, Inc. of Stanley, N.C.). As will be appreciated by one skilled in the art, the porosity and/or consistency of the porous polymer coating may be selectively adjusted (i.e., tuned) by changing the constituents of the porous polymer coating and/or the tool/attachment/settings used to mix the polymer dispersion. For example, the porosity and/or consistency of a porous polymer coating may be selectively adjusted by changing the speed at which the polymer dispersion is mixed and/or the attachment with which the polymer dispersion is mixed.

Porous polymer coatings of the present invention may have any suitable basis weight. In some embodiments, the porous polymer coating has a basis weight of about 1, 2, 3, 4, 5, 6, 7, 8, 9, 10, 15, 20, 25, 30, 25, 40, 45, 50, 55, 60, 65, 70, 75, 80, 85, 90, 95, 100 grams per square meter (gsm) or less. In some embodiments, the porous polymer coating has a basis weight of about 1, 2, 3, 4, 5, 6, 7, 8, 9, 10, 15, 20, 25, 30, 25, 40, 45, 50, 55, 60, 65, 70, 75, 80, 85, 90, 95, 100 gsm or more. In some embodiments, a porous polymer coating of the present invention is applied to a substrate (e.g., a fabric) that has a basis weight of about 10, 15, 20, or 25 gsm to about 30, 35, 40, 45, 50, 55, 60, 65, 70, 75, 80, 85, 90, 95, or 100 gsm.

Porous polymer coatings of the present invention may have an airflow resistance of about 100, 125, 150, 175, 200, 225, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more when tested based on ASTM Standard C522-03, “Standard Test Method for Airflow Resistance of Acoustical Materials,” ASTM International (2009). In some embodiments, the porous polymer coating has an airflow resistance of between about 100, 250, 500, 750, 1,000, 2,000, or 3,000 Rayls and about 4,000, 5,000, 6,000, 7,000, 8,000, 9,000, or 10,000 Rayls.

Porous polymer coatings of the present invention may have an air permeability of about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150 cfm or less. In some embodiments, the porous polymer coating has an air permeability of about 3 cfm and about 100 cfm. In some embodiments, the porous polymer coating has an air permeability of about 3, 5, 7, or 9 cfm to about 10, 15, 20, 25, 30, 35, 40, 45, 50, 55, 60, 65, 70, 75, or 80 cfm.

In some embodiments, a porous polymer coating of the present invention has a density of less than about 2 g/cc when dry, optionally wherein the coating is in the form of a foam. A dry coating may be obtained immediately after exposing the coating to a temperature of about 105° F. for about 30 minutes. In some embodiments, the coating may have a density in a range of about 0.25, 0.3, 0.35, 0.4, 0.45, 0.5, 0.55, 0.6, 0.65, 0.7, or 0.75 g/cc to about 0.8, 0.85, 0.9, 0.95, 1, 1.1, 1.2, 1.3, 1.4, 1.5, 1.6, 1.7, 1.8, 1.9, or 2 g/cc when dry, optionally wherein the coating is in the form of a foam. In some embodiments, a coating of the present invention, when dry, has a density in a range of about 0.2 g/cc to about 0.5 g/cc, about 0.75 g/cc to about 1.25 g/cc, or about 0.9 g/cc to about 1.2 g/cc.

Porous polymer coatings of the present invention may have any suitable porous structure, including, but not limited to, reticulated porous structures and intact porous structures. In some embodiments, a porous polymer coating of the present invention is in the form of a foam, optionally having a film on a surface of the foam or the foam having a film-like surface. In some embodiments, the porous polymer coating comprises a low density, reticulated foam structure. In some embodiments, the porous polymer coating comprises a reticulated foam structure formed by drying an intact foam structure such that intact bubbles/cells are converted to open bubbles/cells. In some embodiments, the porous polymer coating has a void fraction of about 5%, 10%, 15%, 20%, 35%, 30%, 35%, 40%, 45%, 50%, 55%, 60%, 65%, 70%, 71%, 72%, 73%, 74%, 75%, 76%, 77%, 78%, 79%, 80%, 81%, 82%, 83%, 84%, 85%, 86%, 87%, 88%, 89% 90%,91%, 92%, 93%, 94%, 95%, 96%, 97%, 98%, 99% or more.

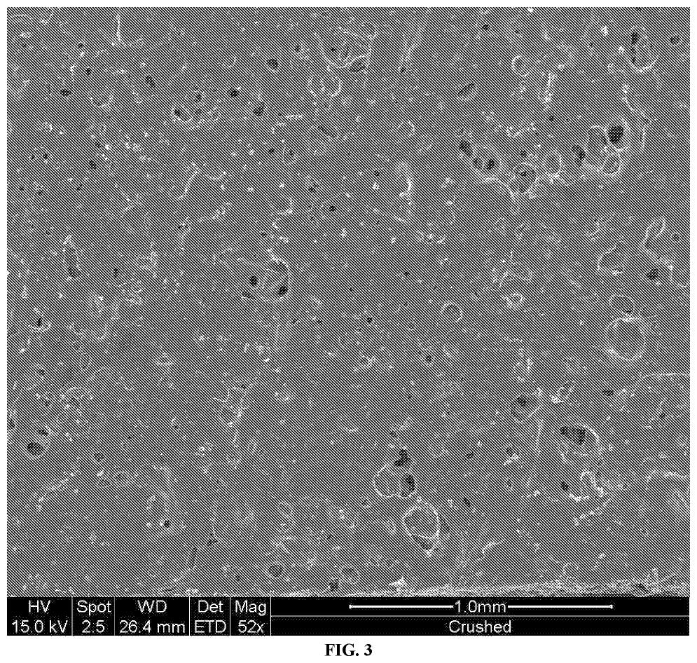

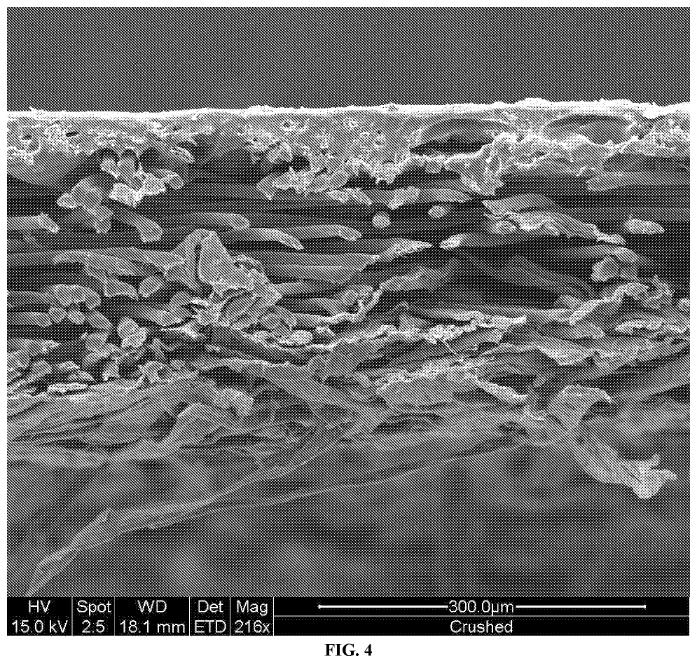

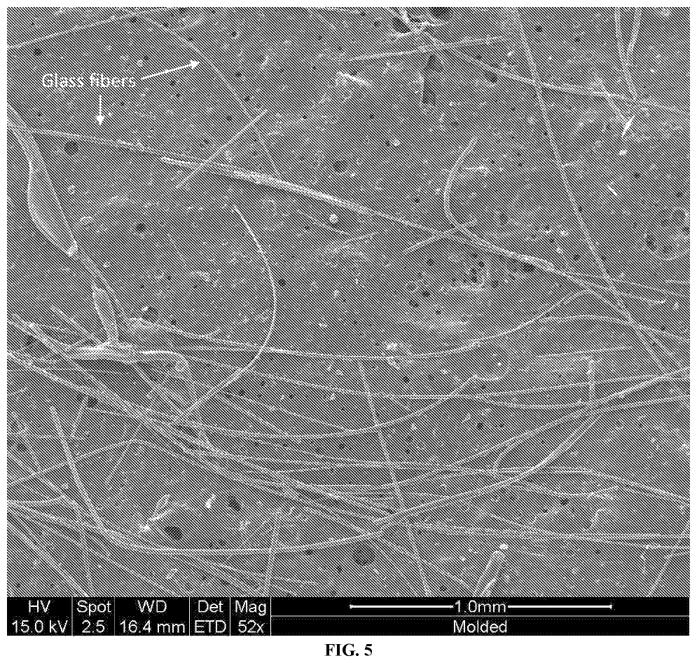

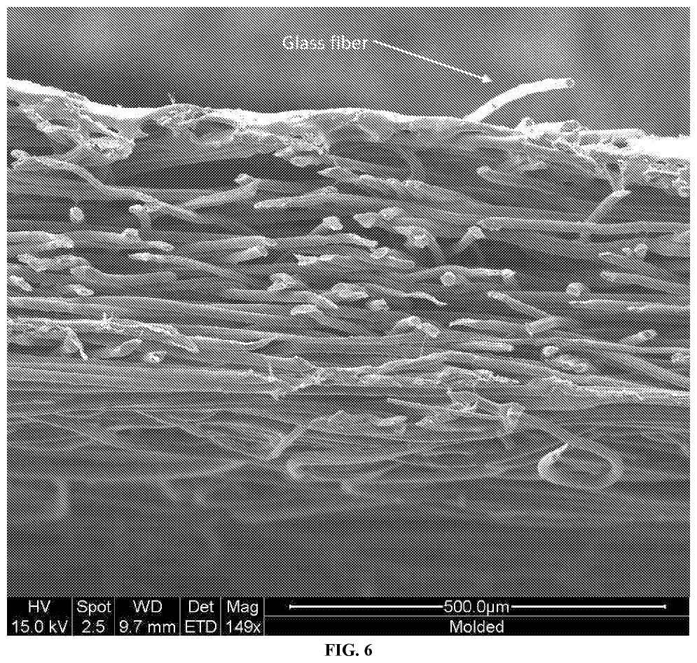

Porous polymer coatings of the present invention may retain their porous structure following compression (as shown in FIGS. 3-4) and/or molding to a substrate (as shown in FIGS. 5-6). In some embodiments, the void fraction of the porous polymer coating is reduced by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95% or less following heat activation and molding/bonding to one or more substrates. In some embodiments, the void fraction of the porous polymer coating is reduced by about 10%, about 25%, about 50% or about 75% following heat activation and molding/bonding to one or more substrates.

Porous polymer coatings of the present invention may have any suitable blow ratio. In some embodiments, the porous polymer coating has a blow ratio of about 1, 2, 3, 4, 5, 6, 7, 8, 9, 10, 11, 12, 13, 14, 15, 16, 17, 18, 19, 20 or more. In some embodiments, the porous polymer coating has a blow ratio of between about 1 and about 10.

Porous polymer coatings of the present invention may be applied to one or more (e.g., 1, 2, 3, or more) substrates to form a composite material. In some embodiments, the composite material comprises a porous polymer coating of the present invention interposed between two substrates. Porous polymer coatings of the present invention may be applied to any suitable substrate, including, but not limited to, batts, fabrics, nets, papers and films. In some embodiments, porous polymer coatings of the present invention are applied to building materials. In some embodiments, porous polymer coatings of the present invention are applied to nonporous substrates, such as a release liner, and then removed from the substrate for use without a substrate.

Porous polymer coatings of the present invention may be applied to any suitable batt, including, but not limited to, homopolymer batts, multifiber batts (e.g., shoddy batts), felts (e.g., needled felts), vertically lapped batts, pleated batts and thermally bonded batts. In some embodiments, porous polymer coatings are applied to batts comprising one or more glass fibers (e.g., glass insulation).

Porous polymer coatings of the present invention may be applied to any suitable type of fabric, including, but not limited to, woven fabrics, nonwoven fabrics and knit fabrics.

Porous polymer coatings of the present invention may be applied to any suitable nonwoven fabric, including, but not limited to, spunlaced fabrics, spunbonded fabrics, needlepunched fabrics, stitchbonded fabrics, thermal bonded fabrics, powder bonded fabrics, chemical bonded fabrics, wet laid fabrics and air laid fabrics. In some embodiments, the porous polymer coating is applied to a spunlaced fabric.

Porous polymer coatings of the present invention may be applied to fabrics that have undergone any suitable mechanical treatment, including, but not limited to, calendaring, creping, embossing, ring rolling and stretching. In some embodiments of the invention the porous coating is applied to a substrate that has been chemically treated for certain properties that include, flame retardancy, oil, alcohol or water repellency, antistat, antimicrobial, corrosion inhibition, color, binders, and the like.

Porous polymer coatings of the present invention may be applied to fabrics having any suitable three-dimensional pattern(s). In some embodiments, porous polymer coatings of the present invention are applied to a nonwoven fabric comprising a three-dimensional pattern that mimics the three-dimensional texture of a woven textile (e.g., hopsack, terrycloth or twill). In some embodiments, porous polymer coatings of the present invention are applied to a nonwoven fabric comprising a three-dimensional pattern such that one or more surfaces of the fabric (e.g., the face of the fabric) has an average surface roughness of greater than about 5, 10, 20, 30, 40, 50, 60, 70, 75, 80, 90, 100, 125, 150, 175, 200, 250, 300, 350, 400, 450, 500, 550, 600, 650, 700, 750, 800, 850, 900, 950, 1000 or more microns (as measured based on the Kawabata Evaluation System (KES) using a KES-FB4 Surface Roughness Tester and/or as measured using a profilometer, for example).

Porous polymer coatings of the present invention may be applied to substrates comprising any suitable fiber type, including, but not limited to, batts/fabrics that comprise, consist essentially of or consist of natural fibers and/or synthetic fibers. In some embodiments, porous polymer coatings of the present invention are applied to batts/fabrics comprising, consisting essentially of or consisting of bamboo fibers, camel hair fibers, graphite fibers, cotton fibers, flax fibers, hemp fibers, jute fibers, polylactic acid fibers, silk fibers, sisal fibers, wood pulp and/or wool (e.g., alpaca, angora, cashmere, chiengora, guanaco, llama, mohair, pashmina, sheep and/or vicuña) fibers. In some embodiments, porous polymer coatings of the present invention are applied to batts/fabrics comprising, consisting essentially of or consisting of acrylic fibers, carbon fibers, fluorocarbon fibers, glass fibers (e.g., melt blown glass fibers, spunbonded glass fibers, air laid glass fibers and wet laid glass fibers), lyocell fibers, melamine fibers, modacrylic fibers, polyacrylonitrile (e.g., oxidized polyacrylonitrile) fibers, polyamide (e.g., nylon and/or aramid) fibers, polybenzimidazole fibers, polyester fibers, polyimide fibers, polylactic acid fibers, polyolefin (e.g., polyethylene and/or polypropylene) fibers, polyphenylene benzobisoxazole fibers, polyphenylene sulfide fibers, polyvinyl acetate fibers, polyvinyl alcohol fibers, polyvinyl chloride fibers, polyvinyl fluoride fibers, polyvinylidene chloride fibers, rayon fibers, viscose fibers, modified viscose (e.g., silica-modified viscose) fibers and/or zylon fibers. In some embodiments, porous polymer coatings of the present invention are applied to batts/fabrics comprising, consisting essentially of or consisting of cellulosic fibers (e.g., bamboo fibers, cellulose acetate fibers, cellulose triacetate fibers, cotton fibers, flax fibers, hemp fibers, jute fibers, lyocell fibers, ramie fibers, sisal fibers ,viscose fibers, rayon fibers, modified viscose (e.g., silica-modified viscose) fibers and/or wood pulp). In some embodiments, porous polymer coatings of the present invention are applied to substrates comprising, consisting essentially of or consisting of bicomponent fibers. For example, porous polymer coatings of the present invention may be applied to substrates comprising, consisting essentially of or consisting of fibers comprising greater than two distinct constituent monomers (e.g., polyester and polypropylene). In some embodiments, porous polymer coatings of the present invention are applied to substrates comprising, consisting essentially of or consisting of continuous fibers. In some embodiments, porous polymer coatings of the present invention are applied to substrates comprising a blend of fibers. (e.g. rayon and polyester). In some embodiments, porous polymer coatings of the present invention are applied to substrates comprising staple fibers. For example, porous polymer coatings of the present invention are applied to batts/fabrics comprising, consisting essentially of or consisting of one or more spunbonded fibers (e.g., flash spunbonded fibers), one or more meltblown fibers and/or one or more spunbonded-meltblown-spunbonded composite fibers. For example, a wet laid substrate such as a paper, a wet-laid nonwoven fabric, or a wet-laid spunlaced fabric may be used.

In some embodiments, a porous polymer coating of the present invention may be applied and/or coated to an untreated substrate (e.g., a substrate that is not treated with a fluorochemical and/or flame retardant), which may eliminate a two-step process and provide for a one step process. In some embodiments, the porous polymer coating is applied to a fabric that has not been treated with a fluorochemical and/or flame retardant. The coating may impart flame retardancy to the composite such as, e.g., due to the use of chlorinated binders, so a substrate (e.g., fabric) does not need to be treated with a flame retardant. In some embodiments, a composite including a coating of the present invention on a fabric that is not treated with a fluorochemical and/or flame retardant may have similar flame retardancy to a composite including the coating on a fabric that has been treated with a fluorochemical and/or flame retardant. In some embodiments, a composite and/or substrate may benefit from being finished with a fluorochemical and/or flame retardant. For example, it may be desirable to add a finishing step in order to pass UL 94 Vertical Flame Testing when rayon and/or woodpulp containing fabrics are used.

Porous polymer coated substrates or composites of the present invention may be subsequently bonded to an additional sound absorbing material to form a multilayer product that has enhanced air flow resistance and/or improved sound absorbing capability. The bonding of the inventive substrate or composite to the additional sound absorbing material may be facilitated by adhesive properties of the coating. The products produced in this way include, but are not limited to, molded sound absorbing panels for vehicles and aircraft, bonded sound absorbing panels for architectural use, sound absorbing materials for ductwork, acoustic and musical end uses such as speakers, panels for auditoriums, and the like.

Porous polymer coatings of the present invention may be applied to a substrate having any suitable basis weight. In some embodiments, a porous polymer coatings of the present invention is applied to a substrate (e.g., a fabric) that has a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900 or 2000 gsm or less. In some embodiments, a porous polymer coatings of the present invention is applied to a substrate (e.g., a fabric) that has a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900, 2000 gsm or more. In some embodiments, a porous polymer coating of the present invention is applied to a substrate (e.g., a fabric) that has a basis weight of about 10 to about 100 gsm. Porous polymer coatings of the present invention may be applied to a substrate having any suitable airflow resistance. In some embodiments, a porous polymer coating of the present invention is applied to a substrate (e.g., a fabric) that has an airflow resistance of about 1, 2, 3, 4, 5, 6, 7, 8, 9, 10, 20, 30, 40, 50, 60, 70, 80, 90, 100, 125, 150, 175, 200, 225, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500 Rayls or more when tested based on ASTM Standard C522-03, “Standard Test Method for Airflow Resistance of Acoustical Materials,” ASTM International (2009). In some embodiments, the porous polymer coating of the present invention is applied to a substrate (e.g., a fabric) that has an airflow resistance of between about 10 and about 1,000 Rayls.

Porous polymer coatings of the present invention may be applied to a substrate having any suitable air permeability. In some embodiments, a porous polymer coating of the present invention is applied to a substrate (e.g., a fabric) that has an air permeability of about 2, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 400, 450, 500, 550, 600, 650, 700, 750, 800, 850, 900, 950, 1000 cfm or more. In some embodiments, the porous polymer coating is applied to a substrate (e.g., a fabric) that has an air permeability of between about 10 and about 1,000 cfm/sq. ft., based on ASTM Standard D737-04, ” “Standard Test Method for Air Permeability of Textile Fabrics,” ASTM International (2012).

Porous polymer coatings of the present invention may be applied to a substrate that is a polymeric foam. Examples include, but are not limited to, urethane foam, foamed rubber both natural and synthetic, foamed polymers such as olefins, polystyrene, acrylates, styrene butadiene, and mixtures of polymers.

Porous polymer coatings of the present invention may be applied to a carpet, which may enhance the sound absorption of the carpet and/or allow for thermally activated bonding of the carpet to another material or surface. Additionally, a substrate coated with the porous coating of the present invention may be bonded to the back of carpet to enhance the sound absorption of the carpet in use.

Porous polymer coatings of the present invention may be applied using any suitable method, including, but not limited to, knife coating, scrape coating, kiss coating, gap coating, foam coating, spray coating, roll coating, gravure coating, screen printing, slot coating, electrostatic coating and/or starved die coating. In some embodiments, the application process com rises greater than partially melting the porous polymer coating. In some embodiments, a porous polymer coating of the present invention is coated and/or foamed onto a surface of a first substrate (e.g., a fabric) and the coating is bonded and/or heat sealed to a surface of a second substrate. The surface of the coating that is not in contact with first substrate is bonded to the second substrate. The airflow resistance of the porous polymer coating may remain the same (or substantially the same) following application (e.g., following the activation and adhesive bonding of the porous polymer coating to one or more substrates). The airflow resistance of the porous polymer coating may change in a predictable manner following application (e.g., following the activation and adhesive bonding of the porous polymer coating to one or more substrates). The porosity or permeability of the coating or coated substrate may be further modified by calendaring, embossing, crushing, or chemical treatment.

Porous polymer coatings of the present invention may impart and/or modulate any suitable characteristic to/of the substrate(s). In some embodiments, the porous polymer coating imparts one or more adhesive properties to and/or modulates one or more adhesive properties of the substrate(s). For example, the porous polymer coating may impart adhesive properties that allow two or more substrates to be molded together to form a composite material. Similarly, the porous polymer coating may increase the adhesiveness of a substrate by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating imparts one or more acoustic properties to and/or modulates one or more acoustic properties of the substrate(s). For example, the porous polymer coating may lower the air permeability of a substrate by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95% or more. Likewise, the porous polymer coating may increase the airflow resistance of a substrate by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating modulates the strength of the substrate(s). For example, the porous polymer coating may increase the strength of the substrate(s) by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating modulates the durability of the substrate(s). For example, the porous polymer coating may increase the durability of the substrate(s) by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more. In some embodiments, the porous polymer coating modulates the abrasion resistance of the substrate(s). For example, the porous polymer coating may increase the abrasion resistance of the substrate(s) 6%, 7%, 8%, 9%, by about 1%, 2%, 3%, 4%, 5%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more.

As indicated above, composite materials of the present invention may comprise any suitable combination of porous polymer coating(s) and substrate(s) and may be formed using any suitable technique.

Composite materials of the present invention may have any suitable basis weight. In some embodiments, composite materials of the present invention have a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900, 2000 gsm or less. In some embodiments, composite materials of the present invention have a basis weight of about 10, 15, 20, 25, 30, 25, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 420, 440, 460, 480, 500, 520, 540, 560, 580, 600, 650, 700, 750, 800, 850, 900, 950, 1000, 1100, 1200, 1300, 1400, 1500, 1600, 1700, 1800, 1900, 2000 gsm or more.

In some embodiments, a composite material of the present invention has a density of less than about 0.5 g/cc, optionally wherein the composite comprises a coating that is in the form of a foam. In some embodiments, the coating may have a density in a range of about 0.05, 0.1, 0.15, 0.2, 0.25 g/cc to about 0.3, 0.35, 0.4, 0.45, 0.5, 0.55, 0.6, 0.65, 0.7, 0.75, 0.8, 0.85, 0.9, 0.95, 1, 1.05, 1.10, 1.15, or 1.2 g/cc, optionally wherein the composite comprises a coating that is in the form of a foam. In some embodiments, a composite of the present invention has a density in a range of about 0.1 g/cc to about 0.3 g/cc. In some embodiments, a composite of the present invention has a density in a range of about 0.9 g/cc to about 1.15 g/cc.

Composite materials of the present invention may demonstrate reduced air permeability. In some embodiments, the air permeability of the composite material is reduced by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%. 97%, 98%, 99% or 100% as compared to a control substrate (i.e., a substrate that lacks the porous polymer coating but is otherwise identical to the composite material) when tested based on ASTM Standard C522-03, “Standard Test Method for Airflow Resistance of Acoustical Materials,” ASTM International (2009); ASTM Standard D737-04, ” “Standard Test Method for Air Permeability of Textile Fabrics,” ASTM International (2012). In some embodiments, the substrate is a fabric (e.g., a nonwoven fabric), and the air permeability of the composite material is reduced by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 96%. 97%, 98%, 99% or 100% as compared to a control fabric having the same amounts/types of fibers, weight, thickness as the fabric of the composite material.

Composite materials of the present invention may demonstrate enhanced airflow resistance. In some embodiments, the airflow resistance of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control substrate (i.e., a substrate that lacks the porous polymer coating but is otherwise identical to the composite material) when tested based on ASTM Standard C522-03, “Standard Test Method for Airflow Resistance of Acoustical Materials,” ASTM International (2009); ASTM Standard D737-04, “ “Standard Test Method for Air Permeability of Textile Fabrics,” ASTM International (2012). In some embodiments, the substrate is a fabric (e.g., a nonwoven fabric), and the airflow resistance of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Composite materials of the present invention may have an airflow resistance of about 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more when based on ASTM Standard C522-03, “Standard Test Method for Airflow Resistance of Acoustical Materials,” ASTM International (2009); ASTM Standard D737-04, “ “Standard Test Method for Air Permeability of Textile Fabrics,” ASTM

International (2012). In some embodiments, the composite material has an airflow resistance of about 100 to about 10,000 Rayls. In some embodiments, the composite material comprises, consists essentially of or consists of one substrate and one porous polymer coating and has an airflow resistance of about 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more. In some embodiments, the composite material comprises, consists essentially of or consists of one substrate and one porous polymer coating and has an airflow resistance of about 100 to about 10,000 Rayls. In some embodiments, the composite material comprises, consists essentially of or consists of a porous polymer coating interposed between two substrates and has an airflow resistance of about 100, 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500, 1600, 1700, 1800, 1900, 2000, 2100, 2200, 2300, 2400, 2500, 2600, 2700, 2800, 2900, 3000, 3200, 3400, 3600, 3800, 4000, 4200, 4400, 4600, 4800, 5000, 5500, 6000, 6500, 7000, 7500, 8000, 8500, 9000, 9500, 10000 Rayls or more. In some embodiments, the composite material comprises, consists essentially of or consists of a porous polymer coating interposed between two substrates and has an airflow resistance of about 100 to about 10,000 Rayls.

Composite materials of the present invention may demonstrate enhanced strength. In some embodiments, the strength of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating but is otherwise identical to the composite material) when tested in based on ASTM Standard D1682-64, “ Standard Test Methods for Breaking Load and Elongation of Textile Fabrics,” ASTM International (1975); ASTM Standard D5034-09, “ Standard Test Methods for Breaking Load and Elongation of Textile Fabrics (Grab Test),” ASTM International (2013); ASTM Standard D5035-11, “ Standard Test Methods for Breaking Load and Elongation of

Textile Fabrics (Strip Method),” ASTM International (2011); ASTM Standard D1117-01, “Standard Guide for Evaluating Nonwoven Fabrics,” ASTM International (2001). In some embodiments, the substrate is a fabric (e.g., a nonwoven fabric), and the strength of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Composite materials of the present invention may demonstrate enhanced durability. In some embodiments, the durability of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating but is otherwise identical to the composite material) when based on ASTM Standard D4157-13, “Standard Test Method for Abrasion Resistance of Textile Fabrics (Oscillatory Cylinder Method),” ASTM International (2013); ASTM Standard D4158-08, “Standard Guide for Abrasion Resistance of Textile Fabrics (Uniform Abrasion),” ASTM International (2012); ASTM Standard D3389-10, “ “Standard Test Method for Coated Fabrics Abrasion Resistance,” ASTM International (2010); ASTM Standard D3885-07a, “Standard Test Method for Abrasion Resistance of Textile Fabrics (Flexing and Abrasion Method),” ASTM International (2011); ASTM Standard D3886-99, “Standard Test Method for Abrasion Resistance of Textile Fabrics (Inflated Diaphragm Apparatus),” ASTM International (2011); ASTM Standard D4966-12, “Standard Test Method for Abrasion Resistance of Textile Fabrics (Martindale Abrasion Tester Method),” ASTM International (2013); ASTM Standard D3884-09, “Standard Test Method for Abrasion Resistance of Textile Fabrics (Rotary Platform, Double-Head Method),” ASTM International (2013); ASTM Standard D3597-02, “Standard Specfication for Woven Upholstery Fabrics-Plain, Tufted or Flocked,” ASTM International (2009); ASTM Standard D4037-02, “ “Standard Performance Specification for Woven, Knitted or Flocked Bedspread Fabrics,” ASTM International (2008); ASTM Standard D1117-01, “Standard Guide for Evaluating Nonwoven Fabrics,” ASTM International (2001). In some embodiments, the substrate is a fabric (e.g., a nonwoven fabric), and the durability of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Composite materials of the present invention may demonstrate enhanced abrasion resistance. In some embodiments, the abrasion resistance of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating but is otherwise identical to the composite material) when tested based on ASTM Standard D4157-13, “Standard Test Method for Abrasion Resistance of Textile Fabrics (Oscillatory Cylinder Method),” ASTM International (2013); ASTM Standard D4158-08, “Standard Guide for Abrasion Resistance of Textile Fabrics (Uniform Abrasion),” ASTM International (2012); ASTM Standard D3389-10, “ “Standard Test Method for Coated Fabrics Abrasion Resistance,” ASTM International (2010); ASTM Standard D3885-07a, “Standard Test Method for Abrasion Resistance of Textile Fabrics (Flexing and Abrasion Method),” ASTM International (2011); ASTM Standard D3886-99, “Standard Test Method for Abrasion Resistance of Textile Fabrics (Inflated Diaphragm Apparatus),” ASTM International (2011); ASTM Standard D4966-12, “Standard Test Method for Abrasion Resistance of Textile Fabrics (Martindale Abrasion Tester Method),” ASTM International (2013); ASTM Standard D3884-09, “Standard Test Method for Abrasion Resistance of Textile Fabrics (Rotary Platform, Double-Head Method),” ASTM International (2013); ASTM Standard D3597-02, “Standard Specification for Woven Upholstery Fabrics-Plain, Tufted or Flocked,” ASTM International (2009); ASTM Standard D4037-02, “ “Standard Performance Specification for Woven, Knitted or Flocked Bedspread Fabrics,” ASTM International (2008); ASTM Standard D1117-01, “Standard Guide for Evaluating Nonwoven Fabrics,” ASTM International (2001). In some embodiments, the substrate is a fabric (e.g., a nonwoven fabric), and the abrasion resistance of the composite material is increased by about 1%, 2%, 3%, 4%, 5%,'6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

Composite materials of the present invention may demonstrate enhanced adhesive properties. In some embodiments, the adhesiveness of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control material (i.e., a substrate that lacks the porous polymer coating but is otherwise identical to the composite material) when tested based on AATTC Standard 136, “Bond Strength of Bonded and Laminated Fabrics,” American Association of Textile Chemists and Colorists, (2012); ASTM Standard D6862-11, “Standard

Test Method for 90 Degree Peel Resistance of Adhesives,” ASTM International (2012); ASTM Standard D3167-10, “Standard Test Method for Floating Roller Peel Resistance of Adhesives,” ASTM International (2010); ASTM Standard D2724-07, “Standard Test Methods for Bonded, Fused, and Laminated Apparel Fabrics,” ASTM International (2011); HN Standard 0192, “Test Method for Determining Bond Strength of Laminated Fabrics,” (2007). In some embodiments, the substrate is a fabric (e.g., a nonwoven fabric), and the adhesiveness of the composite material is increased by about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, 125%, 150%, 175%, 200%, 250%, 300% or more as compared to a control fabric having the same amounts/types of fibers, weight, thickness as the fabric of the composite material.

In some embodiments, a porous polymer coating of the invention may be coated on both the top and bottom surface of a substrate, which may increase the effectiveness of the product. The composite having a coating of the present invention on two sides of a substrate may be used on the top or bottom of a sound absorbing panel, or inserted between two batts, foams, panels, or fabrics to improve, the acoustic performance, the sound absorption ability, or the ability to absorb certain frequencies of sound, by the final product and allow for thermally activated adhesive bonding of the layers. In some embodiments, a porous polymer coating of the invention, with both top and bottom coated onto a substrate, may be inserted between dissimilar materials, such as batts, foams, panels, fabrics, or carpet, and allow for thermally activated adhesive bonding of the layers.

Accordingly, composite materials of the present invention may be suitable for use in numerous applications and products, including, but not limited to, transportation applications, building applications, architectural applications, automobiles, aircraft, air ducts, appliances, baffles, ceiling tiles and office partitions.

### EXAMPLES

The following examples are not intended to be a detailed catalogue of all the different ways in which the present invention may be implemented or of all the features that may be added to the present invention. Those skilled in the art will appreciate that numerous variations and additions to the various embodiments may be made without departing from the present invention. Hence, the following descriptions are intended to illustrate some particular embodiments of the invention, and not to exhaustively specify all permutations, combinations and variations thereof.

### Example 1

A porous polymer coating was formed by introducing a styrene acrylic copolymer mixture according to Formula 2 of Table 2 above into a CFS® foam generator system (Gaston Systems, Inc., Stanley, N.C.) and foaming the mixture using air at around 80 pounds per square inch (psi) and a blow ratio of approximately 3.3. The foam was coated onto a spunbond web comprising polyester (100% by weight) with a nominal basis weight of about 34 gsm using a knife gap of about 40 mils. The coated web was dried in a forced air oven for about 1 minute at approximately 155° C. The dry add-on weight of the porous polymer coating was around 93 gsm. The air permeability of the web prior to application/drying of the porous polymer coating was about 711 cfm. The air permeability of the composite material was about 1 cfm.

### Example 2

A porous polymer coating was formed by introducing a styrene acrylic copolymer mixture according to Formula 2 of Table 2 above into a CFS® foam generator system (Gaston Systems, Inc., Stanley, N.C.) and foaming the mixture using air at around 80 pounds per square inch (psi) and a blow ratio of 5.6. The foam was coated onto a spunbond web comprising polyester (100% by weight) and weighing 34 gsm using a knife gap of 40 mils. The coated web was dried in a forced air oven for 1 minute at 175° C. The dry add-on weight of the porous polymer coating was approximately 46.3 gsm. The air permeability of the web prior to application/drying of the porous polymer coating was about 711 cfm. The air permeability of the composite material was about 74.4 cfm.

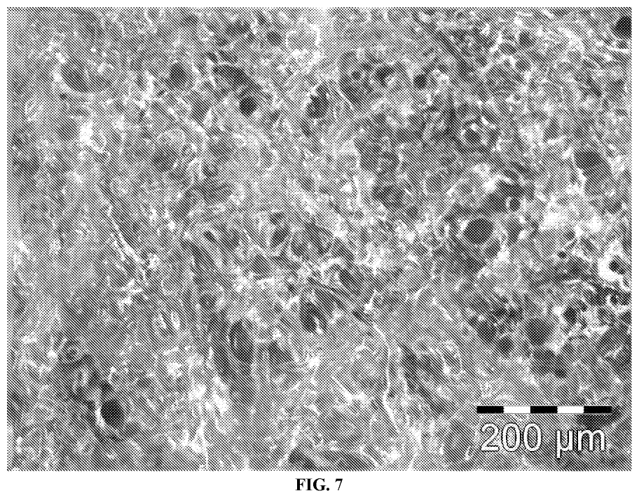

FIG. 7 provides an exemplary image of the porous polymer coating that was added to the polyester spunbond web.

### Example 3

A porous polymer coating was formed by introducing a styrene acrylic copolymer mixture according to Formula 2 of Table 2 above into a CFS® foam generator system

(Gaston Systems, Inc., Stanley, N.C.) and foaming the mixture using air at around 80 pounds per square inch (psi) and a blow ratio of 5.6. The foam was coated onto a spunbond web comprising polyester (100% by weight) with a nominal basis weight of about 34 gsm using a knife gap of 40 mils. The coated web was dried in a forced air oven for 1 minute at 155° C. The dry add-on weight of the porous polymer coating was around 43.6 gsm. The air permeability of the web prior to application/drying of the porous polymer coating was about 711 cfm. The air permeability of the composite material was about 81.8 cfm.

Example 4

A porous polymer coating was formed by introducing a styrene acrylic copolymer mixture according to Formula 2 of Table 2 above into a CFS® foam generator system (Gaston Systems, Inc., Stanley, N.C.) and foaming the mixture using air at around 80 pounds per square inch (psi) and a blow ratio of approximately 5.6. The foam was coated onto a spunbond web comprising polyester (100% by weight) with a nominal basis weight of about 34 gsm using a knife gap of about 40 mils. The coated web was dried in a forced air oven for about 1 minute at around 175° C. The dry add-on weight of the porous polymer coating was around 46.3 gsm.

A 12 inch by 12 inch sample of the composite material was bonded to a 12 inch by 12 inch piece of corrugated kraft cardboard at around 410° F. for about 1 minute using a Tetrahedron press set at 10 tons of pressure and using 135 mil thick shims to control the amount of compression experienced by the composite material (the corrugated kraft cardboard was about 165 mils thick).

After cooling, the cardboard was pulled away from the composite material. A significant portion of the outer facing of the corrugated kraft cardboard remained bonded to the composite material, indicating that the porous polymer coating imparted excellent adhesive properties to the spunbond polyester web.

### Example 5

A porous polymer coating was formed by introducing a mixture comprising a blend of low T_{g} and high T_{g} acrylic binders (−15° F. and +30° F., respectively), APP, thermosetting adhesive powder, foaming agents, and thickeners into a CFS® foam generator system (Gaston Systems, Inc., Stanley, N.C.) and foaming the mixture using air at around 80 pounds per square inch (psi) and a blow ratio of 4. The foam was coated onto five samples of black, flame-retardant, water-repellant spunlaced fabric comprising rayon about (50% by weight) and polyester about (50% by weight) and weighing on average 91 gsm, using a parabolic foam applicator with a 0.030″ gap that was setup between the pins of a pilot line tenter frame. The coated fabric samples were dried in a forced air oven at about 150° C. for a period of time ranging from about 30 seconds to about 1 minute. Drying times were varied to allow for changes in add-on of the coating. The air permeability of the fabric samples prior to application/drying of the porous polymer coating was on average about 213 cfm.

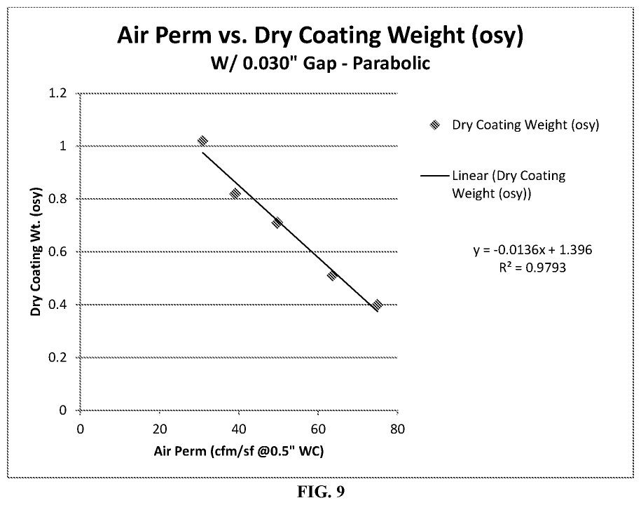

The dry add-on weights of the porous polymer coatings and the air permeabilities of the resultant composite materials are shown in Table 3 and in FIG. 9.

TABLE 3
Characteristics of the composite materials described in Example 5.

| | Dry Add-On Weight | Avg. Air Perm |
|---|---|---|
| Sample | (osy) | (cfm) |
| Control (uncoated) | 0.0 | 213 |
| 1 | 0.4 | 75 |
| 2 | 0.5 | 64 |
| 3 | 0.7 | 50 |
| 4 | 0.8 | 39 |
| 5 | 1.0 | 31 |

### Example 6

A porous polymer coating was formed by introducing UNIBOND 2780B (Unichem, Inc., Haw River, N.C.) into a CFS® foam generator system (Gaston Systems, Inc., Stanley, N.C.) and foaming the mixture using air at around 80 pounds per square inch (psi) and a blow ratio of 4. The foam was coated onto seven samples of black, flame-retardant, water-repellant spunlaced fabric comprising woodpulp (about 55% by weight) and polyester (about 45% by weight) and weighing on average about 72 gsm using a parabolic foam applicator with a 0.020″ gap that was setup between the pins of a pilot line tenter frame. The coated fabric samples were dried in a forced air oven at about 150° C. for a period of time ranging from about 30 seconds to about 1 minute. The air permeability of the fabric samples prior to application/drying of the porous polymer coating was on average about 66 cfm.

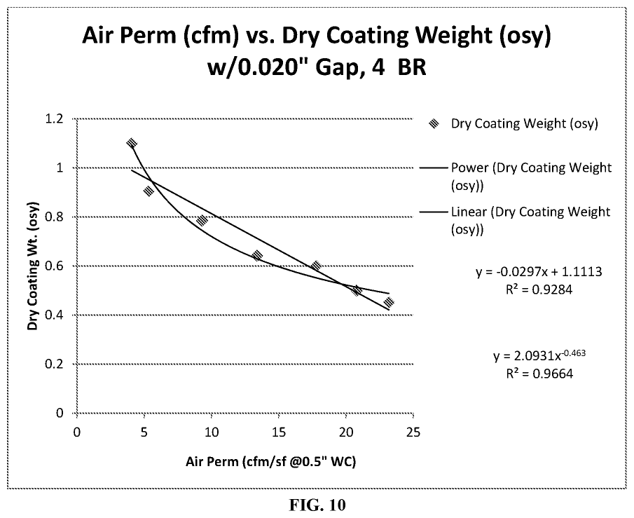

The dry add-on weights of the porous polymer coatings and the air permeabilities of the resultant composite materials are shown in Table 4 and in FIG. 10.

TABLE 4
Characteristics of the composite materials described in Example 6.

| Sample | Dry Add-On Weight (osy) | Avg. Air Perm (cfm) |
|---|---|---|
| Control (uncoated) | 0.0 | 66 |
| 1 | 0.45 | 23 |
| 2 | 0.5 | 21 |
| 3 | 0.6 | 18 |
| 4 | 0.65 | 13 |
| 5 | 0.79 | 9 |
| 6 | 0.9 | 5 |
| 7 | 1.1 | 4 |

### Example 7

A porous polymer coating was formed by introducing UNIBOND 2780B (Unichem, Inc., Haw River, N.C.) into a CFS® foam generator system (Gaston Systems, Inc., Stanley, N.C.) and foaming the mixture using air at around 80 pounds per square inch (psi) and a blow ratio of 4. The foam was coated onto a black, flame-retardant, water-repellant spunlaced fabric comprising woodpulp (about 55% by weight) and polyester (about 45% by weight) and weighing on average about 72 gsm using a segmented foam applicator and a tenter frame. The coated fabric samples were dried in a forced air oven for about 30 seconds at about 275° F. The dry add-on weight of the porous polymer coating was on average about 0.8 ounces per square yard (osy). The air permeability of the fabric sample prior to application/drying of the porous polymer coating was on average about 66 cfm. The air permeability of the composite material was on average about 30 cfm.

### Example 8

A porous polymer coating was formed by introducing UNIBOND 2780B (Unichem, Inc., Haw River, N.C.) into a CFS® foam generator system (Gaston Systems, Inc., Stanley, N.C.) and foaming the mixture using pressurized air at around 80 pounds per square inch (psi) and a blow ratio of 4. The foam was coated onto a black, flame-retardant, water-repellant spunlaced fabric comprising woodpulp (about 55% by weight) and polyester (about 45% by weight) and weighing on average about 72 gsm using a segmented foam applicator and a tenter frame. The coated fabric samples were dried in a forced air oven for about 30 seconds at about 300° F. The dry add-on weight of the porous polymer coating was approximately 0.8 ounces per square yard (osy). The air permeability of the fabric sample prior to application/drying of the porous polymer coating was on average about 66 cfm. The air permeability of the composite material was on average about 19 cfm.

### Example 9

A porous polymer coating was formed by introducing a styrene acrylic copolymer mixture according to Formula 2 of Table 2 above into a CFS® foam generator system (Gaston Systems, Inc., Stanley, N.C.) and foaming the mixture using air at around 80 pounds per square inch (psi) and a blow ratio of around 10.4. The foam was coated onto a spunbond/meltblown/spunbond web comprising polypropylene (100% by weight) with a nominal basis weight around 44 gsm using a knife gap of about 40 mils. The coated web was dried in a forced air oven for 1 minute at 140° C. The dry add-on weight of the porous polymer coating was about 14.1 gsm. The air permeability of the web prior to application/drying of the porous polymer coating was about 40 cfm. The air permeability of the composite material was about 28.3 cfm.

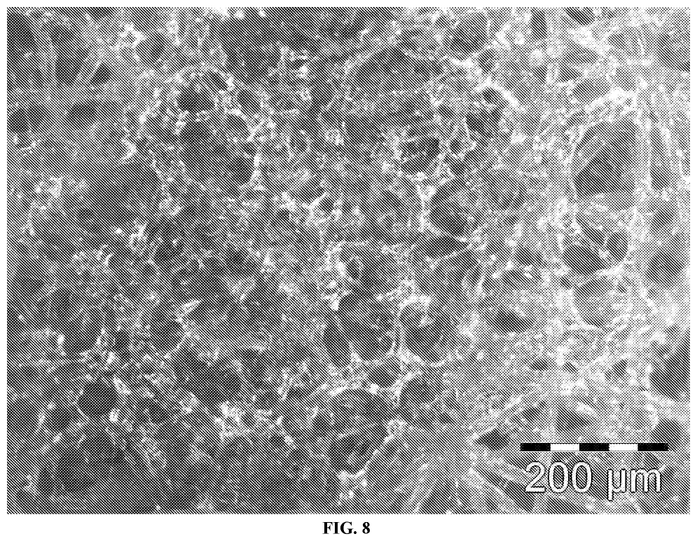

FIG. 8 provides an exemplary image of the porous polymer coating that was added to the polypropylene spunbond/meltblown/spunbond web.

The composite material was bonded to a 0.8 inch thick, 430 gsm nonwoven batt comprising polyester (about 80% to about 99% by weight) and a lower melt polymer (about 1% to about 20% by weight) (Vita Nonwovens, LLC, High Point, N.C.) as outlined below:
A Despatch LBB/LED Series 2400 Watt, 20 amp convection oven (Despatch Industries, Minneapolis, MN), which is capable of heating to a temperature of 200-400° F. and of maintaining a temperature within ±3° F. of a target temperature, was preheated to 193° F.
A 12 inch by 12 inch aluminum plate weighing 1600 grams was placed in the oven and allowed to stabilize to 193±3° F. The temperature of the aluminum plate was confirmed using a contact thermocouple (measuring the temperature of the middle of the plate and of each corner of the plate).
A 12 inch by 12 inch sample of the composite material was placed on the bench top with the porous polymer coating facing up.
The composite material sample was overlaid with a 12 inch by 12 inch piece of the nonwoven batt (ensuring that the edges of the composite material and the batt were aligned).
The composite-batt stack was placed in the oven atop the preheated aluminum plate with the nonwoven batt facing up (ensuring that the edges of the preheated aluminum plate and the composite-batt stack were aligned).
After 15 seconds, a 12 inch by 12 inch aluminum plate weighing 2400-2500 grams was placed in the oven atop the preheated aluminum plate and the composite-batt stack (ensuring that the edges of the aluminum plates and the composite-batt stack were aligned).
After 45 seconds, the top plate was removed and the composite-batt stack was removed from the oven and placed on the bench top to cool for 5 minutes.

The bond between the porous polymeric layer of the composite material and the nonwoven batt had an average peel strength of over 100 grams/inch when tested based on ASTM D903-98. (“Standard Test Method for Peel or Stripping Strength of Adhesive Bonds,” ASTM International (2010)),

Example 10

A porous polymer coating was formed by introducing a styrene acrylic copolymer mixture according to Formula 3 of Table 2 above into a CFS® foam generator system (Gaston Systems, Inc., Stanley, N.C.) and foaming the mixture using air at around 80 pounds per square inch (psi) and a blow ratio of approximately 4.3. The foam was coated onto samples of a spunbond web comprising polyester (100% by weight) with a nominal basis weight of about 34 gsm using a rounded coating blade and a gap of about 15, 22 or 29 mils. The coated web was dried in a forced air oven for about 1 minute at approximately 155° C. When tested based on ASTM Standard D3776-09 (“Standard Test Methods for Mass per Unit Area (Weight) of Fabric,” ASTM International (2013)), the dry add-on weights of the porous polymer coatings were around 1.40, 1.98 and 2.61 osy, respectively. The air permeability of the sampled web prior to application/drying of the porous polymer coating averaged about 711 cfm. When tested based on ASTM Standard D737-96 (“Standard Test Method for Air Permeability of Textile Fabrics,” ASTM International (1996)), the air permeabilities of the composite materials were approximately 113, 52 and 15 cfm, respectively.

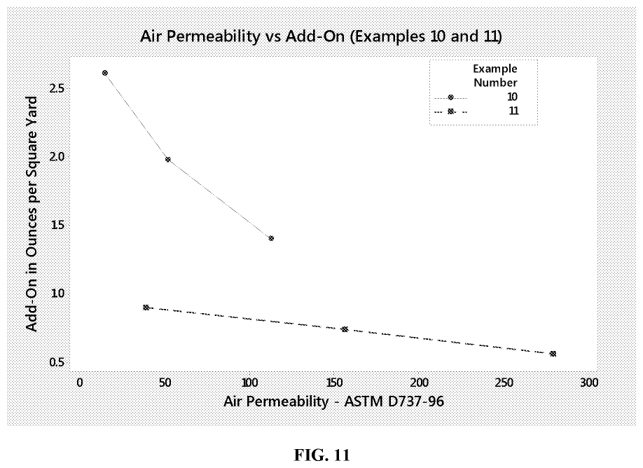

The dry add-on weights of the porous polymer coatings and the air permeabilities of the resultant composite materials are shown in Table 5 and in FIG. 11 (spheres).

TABLE 5
Characteristics of the composite materials described in Example 10.

| Coating Gap | Dry Add-On Weight | Avg. Air Perm. |
|---|---|---|
| (mil) | (osy) | (cfm) |
| 15 | 1.4 | 113.0 |
| 22 | 1.98 | 52.4 |
| 29 | 2.61 | 15.6 |

Example 11

A porous polymer coating was formed by introducing a styrene acrylic copolymer mixture according to Formula 4 of Table 2 above into a CFS® foam generator system (Gaston Systems, Inc., Stanley, N.C.) and foaming the mixture using air at around 80 pounds per square inch (psi) and a blow ratio of approximately 5. The foam was coated onto samples of a spunbond web comprising polyester (100% by weight) with a nominal basis weight of about 34 gsm using a rounded coating blade and a gap of about 15, 22 or 29 mils. The coated web was dried in a forced air oven for about 1 minute at approximately 155° C. When tested based on ASTM Standard D3776-09 (“Standard Test Methods for Mass per Unit Area (Weight) of Fabric,” ASTM International (2013)), the dry add-on weights of the porous polymer coatings were around 0.56, 0.74 and 0.90 osy, respectively. The air permeability of the sampled web prior to application/drying of the porous polymer coating averaged about 711 cfm. When tested based on ASTM Standard D737-96 (“Standard Test Method for Air Permeability of Textile Fabrics,” ASTM International (1996)), the air permeabilities of the composite materials were approximately 279, 155 and 39 cfm, respectively.

The dry add-on weights of the porous polymer coatings and the air permeabilities of the resultant composite materials are shown in Table 6 and in FIG. 11 (squares).

TABLE 6
Characteristics of the composite materials described in Example 11.

| Coating Gap | Dry Add-On Weight | Avg. Air Perm. |
|---|---|---|
| (mil) | (osy) | (cfm) |
| 15 | 0.56 | 279.7 |
| 22 | 0.74 | 155.5 |
| 29 | 0.90 | 39.2 |

### Example 12

A porous polymer coating was formed by introducing a styrene acrylic copolymer mixture according to Formula 3 of Table 2 above into a CFS® foam generator system (Gaston Systems, Inc., Stanley, N.C.) and foaming the mixture using air at around 80 pounds per square inch (psi) and a blow ratio of approximately 4.3. The foam was coated onto samples of a spunbond web comprising polyester (100% by weight) with a nominal basis weight of about 34 gsm using a rounded coating blade and a gap of about 15, 22 or 29 mils. The coated web was dried in a forced air oven for about 1 minute at approximately 155° C. When tested based on ASTM Standard D3776-09 (“Standard Test Methods for Mass per Unit Area (Weight) of Fabric,” ASTM International (2013)), the dry add-on weights of the porous polymer coatings were approximately 1.40, 1.98 and 2.61 osy, respectively. The air permeability of the sampled web prior to application/drying of the porous polymer coating averaged about 711 cfm. When tested based on ASTM Standard D737-96 (“Standard Test Method for Air Permeability of Textile Fabrics,” ASTM International (1996)), the air permeabilities of the composite materials were reduced by approximately 556, 616 and 653 cfm, respectively.

The dry add-on weights of the porous polymer coatings and the air permeability reductions and air permeability reduction efficiencies of the resultant composite materials are shown in Table 7.

TABLE 7
Characteristics of the composite materials described in Example 12.

| Coating | | Avg. Air Perm. | Avg. Air Perm. |
|---|---|---|---|
| Gap | Dry Add-On Weight | Reduction | Reduction Efficiency |
| (mil) | (osy) | (cfm) | (cfm/osy) |
| 15 | 1.4 | 556.0 | 397.72 |
| 22 | 1.98 | 616.6 | 311.72 |
| 29 | 2.61 | 653.4 | 250.75 |

Average air permeability reduction efficiency is defined by the average of air permeability reduction in cubic feet per minute (cfm) divided by the dry coating add-on (osy).

Example 13

A porous polymer coating was formed by introducing a styrene acrylic copolymer mixture according to Formula 4 of Table 2 above into a CFS® foam generator system (Gaston Systems, Inc., Stanley, N.C.) and foaming the mixture using air at around 80 pounds per square inch (psi) and a blow ratio of approximately 5. The foam was coated onto samples of a spunbond web comprising polyester (100% by weight) with a nominal basis weight of about 34 gsm using a rounded coating blade and a gap of about 15, 22 or 29 mils. The coated web was dried in a forced air oven for about 1 minute at approximately 155° C. When tested based on ASTM Standard D3776-09 (“Standard Test Methods for Mass per Unit Area (Weight) of Fabric,” ASTM International (2013)), the dry add-on weights of the porous polymer coatings were around 1.40, 1.98 and 2.61 osy, respectively. The air permeability of the sampled web prior to application/drying of the porous polymer coating averaged about 711 cfm. When tested based on ASTM Standard D737-96 (“Standard Test Method for Air Permeability of Textile Fabrics,” ASTM International (1996)), the air permeabilities of the composite materials were reduced by 389.3, 513.5 and 629.8 cfm, respectively.

The dry add-on weights of the porous polymer coatings and the air permeability reductions and air permeability reduction efficiencies of the resultant composite materials are shown in Table 8.

TABLE 8
Characteristics of the composite materials described in Example 13.

| Coating | | Avg. Air Perm | Avg. Air Perm. |
|---|---|---|---|
| Gap | Dry Add-On Weight | Reduction | Reduction Efficiency |
| (mil) | (osy) | (cfm) | (cfm) |
| 15 | 0.56 | 389.3 | 697.77 |
| 22 | 0.74 | 513.5 | 692.25 |
| 29 | 0.90 | 629.8 | 699.56 |

Example 14

A porous polymer coating was formed by introducing a mixture according to Formula 1 of Table 2 above into a CFS® foam generator system (Gaston Systems, Inc., Stanley, N.C.) and foaming the mixture using air at around 80 pounds per square inch (psi) and a blow ratio of approximately 4.3. The foam was coated onto samples of a spunbond web comprising polyester (100% by weight) and weighing 34 gsm using a rounded coating blade and a gap of about 15, 22 or 29 mils. The coated web was dried in a forced air oven for about 1 minute at approximately 155° C. When tested based on ASTM Standard D3776-09 (“Standard Test Methods for Mass per Unit Area (Weight) of Fabric,” ASTM International (2013)), the dry add-on weights of the porous polymer coatings were around 1.40, 1.98 and 2.61 osy, respectively.

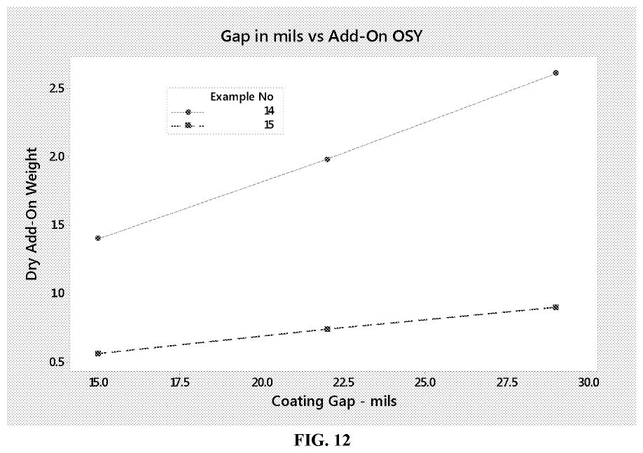

The dry add-on weights of the porous polymer coatings are shown in Table 9 and in FIG. 12 (spheres).

TABLE 9
Characteristics of the composite materials described in Example 14.

| Coating Gap | Dry Add-On Weight |
|---|---|
| (mil) | (osy) |
| 15 | 1.40 |
| 22 | 1.98 |
| 29 | 2.61 |

A 12 inch by 12 inch sample of the composite material was bonded to a 12 inch by 12 inch piece of corrugated kraft cardboard at 430° F. for in minute using 5 tons of pressure and 135 mil thick shims to control the amount of compression experienced by the composite material (the corrugated kraft cardboard was about 165 mils thick). This was done using a Tetrahedron press, model number 1301 (from Tetrahedron Associates, Inc., San Diego, Calif.) according to the manufacturer's instructions.

After cooling, the cardboard was pulled away from the composite material. A significant portion of the outer facing of the corrugated kraft cardboard remained bonded to the composite material, indicating that the porous polymer coating imparted excellent adhesive properties to the spunbond polyester web.

Example 15

A porous polymer coating was formed by introducing a styrene acrylic copolymer mixture according to Formula 2 of Table 2 above into a CFS® foam generator system (Gaston Systems, Inc., Stanley, N.C.) and foaming the mixture using air at around 80 pounds per square inch (psi) and a blow ratio of approximately 3.3. The foam was coated onto samples of a spunbond web comprising polyester (100% by weight) with a nominal basis weight of about 34 gsm using a rounded coating blade and a gap of about 15, 22 or 29 mils.

The coated web was dried in a forced air oven for about 1 minute at approximately 155° C. When tested based on ASTM Standard D3776-09 (“Standard Test Methods for Mass per Unit Area (Weight) of Fabric,” ASTM International (2013)), the dry add-on weights of the porous polymer coatings were around 0.56, 0.74 and 0.90 osy, respectively.

The dry add-on weights of the porous polymer coatings are shown in Table 10 and in FIG. 12 (squares).

TABLE 10
Characteristics of the composite materials described in Example 15.

| Coating Gap | Dry Add-On Weight |
|---|---|
| (mil) | (osy) |
| 15 | 0.56 |
| 22 | 0.74 |
| 29 | 0.90 |

A 12 inch by 12 inch sample of the composite material was bonded to a 12 inch by 12 inch piece of corrugated kraft cardboard at 410° F. for in minute using 10 tons of pressure and 135 mil thick shims to control the amount of compression experienced by the composite material (the corrugated kraft cardboard was about 165 mils thick).

After cooling, the cardboard was pulled away from the composite material. A significant portion of the outer facing of the corrugated kraft cardboard remained bonded to the composite material, indicating that the porous polymer coating imparted excellent adhesive properties to the spunbond polyester web.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

Example 16

Foamed acoustic coatings were prepared using compositions provided in Table 14. The coatings were formed using CFS® foam generator system (Gaston Systems, Inc., Stanley, N.C.) and foaming the compositions was achieved using air at around 80 pounds per square inch (psi). The blow ratio used for Formulation D is approximately 4.3 and the blow ratio used for Formulations E and F is 3.0. The foam was coated onto various substrates indicated in the tables below. The coated web was dried on a production tenter frame for about 1 minute (depending on substrate) at approximately 177° C.

Coated fabric samples were prepared at a dry add-on of approximately 60 gsm on to 54 gsm spunlace greige (70% PET/30% rayon) to compare the affect of clay in the coating formulation. Formulation D from Table 14 below was compared to the same coating with the addition of 22% (dry solids) or 8.75% (wet basis) of Imerys Barrisurf HX clay. After applying and drying, both samples were subjected to a temperature of 380° F. for 2.5 minutes to simulate end user processes. Air permeability of the samples was measured prior to and after heating.

TABLE 14
Compositions for foamed acoustic coatings.

| | Formulation | Formulation | Formulation |
|---|---|---|---|
| Ingredient (% by weight, wet) | D | E | F |
| Water | 40 | 38.17 | 39.25 |
| Sodium Polyacrylate dispersant | | 0.49 | 0.5 |
| Ammonium phosphate | 1.6 | | |
| Ammonium PolyPhosphate | 7 | | |
| Kaolin Clay - | 0 | 8.51 (22% | 8.7 (22% dry |
| Aspect Ratio >5:1 | | dry solids) | solids) |
| Aluminum TriHydrate | | 6.56 | 6.74 |
| Adhesive powder | 1 | | |
| Alkali Swellable Thickener | | 1.75 | 1.8 |
| Blend | | | |
| Thickener - Acrylic thickener | 3.3 | | |
| Vinyl chloride ethylene vinyl | | 36.47 | 37.5 |
| ester acrylate terpolymer binder | | | |
| Mixture of soft and stiff acrylic | 43.1 | | |
| binders | | | |
| Carbon Black Dispersion | 1 | 0.49 | 0.5 |
| Ammonium Lauryl Sulfate | | 0.1 | 0.1 |
| Foaming Agents and | 3 | | |
| pH Adjustment | | | |
| Ammonium Stearate | | 1.95 | 2.00 |
| N-Octyl-Sulfosuccinamate | | 2.67 | 2.75 |
| Biocide | | 0.1 | 0.10 |
| Fluorochemical - Daikin | | 2.75 | |
| Unidyne TG5502 | | | |
| Total | 100 | 100 | 100 |

Table 11 compares the Change of Air Permeability of Formulation D with the incorporation of Barrisurf HX at a level of 22% in the coating solids vs Formulation D with no clay incorporation. Table 11 demonstrates the impact of clay pigments on the air permeability stability of the samples when they are heated as described above.

TABLE 11
Effect on Air Permeability Heat Stability of Clay
Incorporation in Formulation D.

| | Air | Air | | |
|---|---|---|---|---|
| | Perm | Perm | | |
| | (CFM) | (CFM) | | |
| Sample | Prior | After | Delta Air | % Delta Air |
| Coating | to Heat | Heat | Permeability | Permeability |
| Formulation | 42.6 | 138.0 | 95.4 | 224% |
| D | | | | |
| Formulation | 84.2 | 105.2 | 21 | 25% |
| D with 22% | | | | |
| Clay | | | | |

3.7 osy PET needle-punch fabric having a thickness in a range of about 0.036 inches to about 0.044 inches was used as the surrogate “bond-to” substrate for bond testing with two different formulations. Coatings used were Formulation D from Table 14 with and without 22% Clay

(Imerys Barrisurf HX) incorporated by weight of the solids and Formulation A from Table 1 with and without 22% Clay (Imerys Barrisurf HX) incorporated by weight of the solids. The foamed coating formulations were separately applied onto at 54 gsm spunlace greige (70% PET/30% rayon) at a dry add-on of approximately 60 gsm, and dried in laboratory tenter frame to provide a dried fabric sample. The dried fabric sample was then stacked (like sandwich) with the coated side facing the 3.7 osy PET needle-punch fabric (i.e., with the coating of Formulation D or Formulation A facing and/or in contact with a surface of the PET needle-punch fabric), but are not bonded together to provide stacked sample (pre-bonded sample). The air permeability was measured for the stacked sample. Then, the stacked sample was bonded at a temperature of 380° F. for 1 minute at a set gap of 0.05 inches (resulting in less than 10 psi pressure) to provide a bonded sample in which the coating is adhered to the 3.7 osy PET needle-punch. The air permeability of the bonded sample was then measured. The change in air permeability, or “Delta Air Permeability” is the difference between these two measurements (i.e., the pre-bonded and post-bonded measurements).

Tables 12 and 13 show the impact of clay incorporation Imerys Barrisurf HX clay in Formulation D and Formulation A coating formulations on the stability of the coated-fabric's air permeability when the fabric is subjected to a simulation of a manufacturers bonding process (bonding at 380° F. at a pressure of <10 psi for one minute). As clay content is increased, the change in air flow before and after the bonding process is substantially reduced demonstrating the positive effect of incorporating clay into the coating formulation.

TABLE 12
Effect on Air Permeability Stability during Bonding of Clay
Incorporation in Formulation D.

| | Air Perm | Air Perm | | |
|---|---|---|---|---|
| | (CFM) | (CFM) | | |
| Sample | Prior to | After | Delta Air | % Delta |
| Coating | Bonding | Bonding | Permeability | Air Permeability |
| Formulation | 46.0 | 19.4 | 26.6 | 58% |
| D | | | | |
| Formulation | 39.2 | 25.8 | 13.4 | 34% |
| D with | | | | |
| 22% Clay | | | | |

TABLE 13
Effect on Air Permeability Stability during Bonding of Clay
Incorporation in Formulation A.

| | Air | Air | | |
|---|---|---|---|---|
| | Perm | Perm | | |
| | (CFM) | (CFM) | | |
| Sample | Prior to | After | Delta Air | % Delta Air |
| Coating | Bonding | Bonding | Permeability | Permeability |
| Formulation | 19.08 | 13.70 | 5.38 | 28% |
| A | | | | |
| Formulation | 17.3 | 16.4 | 1.97 | 6% |
| A with 22% | | | | |
| Clay | | | | |

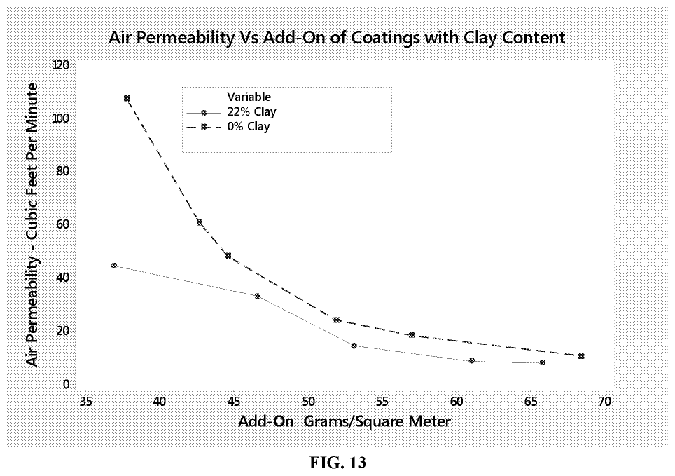

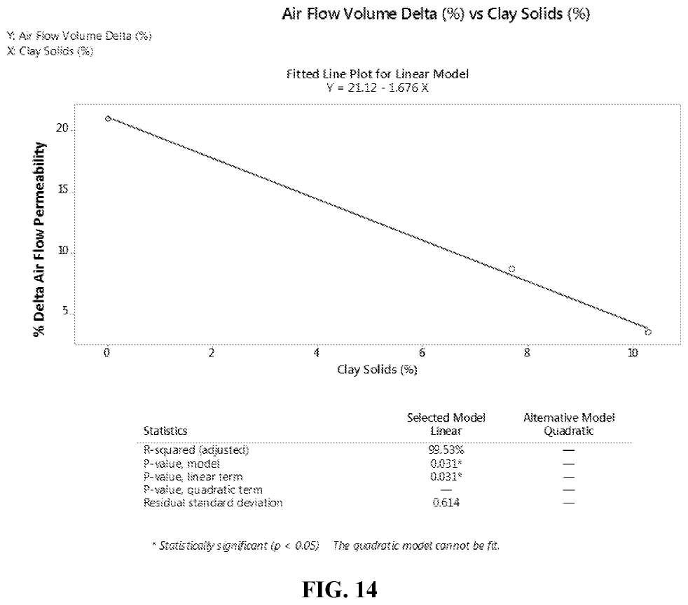

FIG. 13 and FIG. 14 show the impact of incorporation of Barrisurf HX clays into a coating (which is similar to Formulation E in Table 14) on the air permeability of two substrates. FIG. 13 shows a porous base fabric (54 gsm untreated 70/30 PET/Rayon spunlace) with a starting air permeability of approximately 385 cfm. FIG. 14 shows a less porous, treated fabric (54 gsm fluorocarbon-treated wood pulp PET spunlace). The samples in FIG. 14 were generated using a coating add-on of 42 gsm.

FIG. 13 suggests that clay can be used to provide a coating that can achieve a specific air permeability target on porous fabric without the need to incorporate hold-out treatments via fabric finishing.

FIG. 14 shows that with the incorporation of higher concentrations of high-aspect ratio clays in a coating formulation, more stable (lower % Delta Air Permeability) air permeabilities can be achieved before and after bonding (as described previously). Similarly, both FIGS. 13 and 14 show that a higher percentage of clay in the coating formulation lower air permeability of the coating. Data for FIG. 13 were generated on the 54 gsm 70/30 PET/rayon spunlace, which has a uncoated air permeability of 385 cfm. Data for FIG. 14 were generated with 42 gsm of coating on a finished 53 gsm wood pulp/PET spunlace, which has an uncoated air permeability of 135 cfm.

Example 17

Foamed acoustic coatings were prepared having compositions provided in Table 14. The compositions were formed using CFS® foam generator system (Gaston Systems, Inc., Stanley, N.C.) and foaming the mixture was achieved using air at around 80 pounds per square inch (psi). The blow ratio used for Formulation D is approximately 4.3 and the blow ratio used for Formulations E and F is 3.0. The foam was coated onto various substrates indicated in the Tables below. The coated web was dried on a production tenter frame for about 1 minute (depending on substrate) at approximately 177° C.

Compared to Formulation D, Formulation E provided the following benefits:
1. The option of consolidating the manufacturing process from a two-step coating and finishing system to a one step coating. Formulation E allows for an unfinished fabric to be used because the coating provides more efficient air permeability (by allowing the coating to remain on the surface of the fabric), flame retardancy and water resistance. Formulation D requires the fabric to be finished (treated) prior to coating to prevent coating penetration (hold the coating on the surface), impart flame retardancy and water repellency.
2. A reduction in the change in air permeability (delta air permeability). This reduction was achieved when a coated fabric as provided in Table 15 was tested before and after bonding/heat sealing to a 600 gsm 100% PET shoddy nonwoven substrate at 380° F. compressed to 33% of original thickness. Formulation E provides lower (better) delta air permability after bonding even when applied to an unfinished 100% PET fabric compared to Formulation D applied to finished PET/Rayon blend (Table 15).
3. Improved or equivalent bond strengths of the coated fabrics before and after bonding between the coated fabric and an extraneous part or fabric on the extraneous part (Table 16)
4. The benefit of passing the MVSS 302 flame retardancy test with a coating that includes a chlorinated binder and hydrated flame retardant and that is devoid of traditional flame retardants (e.g., ammonium polyphosphate (APP) or phosphate esters);
5. Excellent performance in the 1 hour and 3 hour water drop hold out tests (GMW-16522) as shown in the Table 17.

TABLE 15
Comparison of Delta Air Permeability after bonding a fabric, which
is coated with either Formulation D or E, to shoddy fabric.

| | Finished 70/30 | Unfinished 100% PET |
|---|---|---|
| Fabric | PET/Rayon | Fiber Spunlace |
| Coating | Formulation D | Formulation E |
| formulation | | |
| Average Delta Air | 25.8 | 7.1 |
| Permeability | | |
| (increased) | | |
| Average % in | 160 | 59 |
| Delta Air | | |
| Permeability | | |
| (increased) | | |

TABLE 16
Bond strengths for fabrics coated with Formulation D or Formulation E
that are bonded to 3.7 osy 100% PET Needlepunch.

| Fabric | Wood Pulp/Polyester | | All PET Fiber Spunlaced | |
|---|---|---|---|---|
| Coating | Formulation | Formulation | Formulation | Formulation |
| formulation | D | E | D | E |
| Mean Bond | 659 | 1182 | 899 | 812 |
| Strength | | | | |
| PFG DJT-LAB-81 | | | | |

TABLE 17
Water drop test results for Formulation E and Formulation F.

| | Formulation E | Formulation F |
|---|---|---|
| | (has 2.75% | (has 0% |
| Coating formulation | fluorochemical) | fluorochemical) |
| Coating Dry Add-On | 59.9 | 58.0 |
| (gsm) | | |
| Coated Fabric Basis | 118.4 | 114.2 |
| Weight (gsm) | | |
| Water Drop Test 1 HR | Pass | Fail |
| (Pass/Fail) | | |
| Water Drop Test 3 HR | Pass | Fail |
| (Pass/Fail) | | |

It was further unexpectedly discovered that by adding clay to coatings including chlorine containing binders we were able to achieve equivalent air permeability with lower coating weights (see, e.g., FIG. 13 comparing Formulation A (with 22% kaolin clay) to the same formulation with having 0% kaolin clay). In addition, the blocking force and blocking that causes off-quality coating production processes was eliminated as shown in Table 18. Blocking can occur when a coated surface undesirably bonds to another surface or bonds to another surface prematurely, especially in a roll of fabric where the coating bonds to the back side of the adjacent layer. A peel force of 0 g/inch indicates that the coating is not adhered to a surface. The percent off quality of production for blocking was determined by determining the yards rejected, which were the yards that were unable to be unwound from a roll due to adherence, compared to the gross yards produced.

TABLE 18
Percent Off Quality Results.

| Fabric | Wood Pulp/Polyester | | All PET Fiber Spunlaced | |
|---|---|---|---|---|
| Coating | Formulation | Formulation | Formulation | Formulation |
| formulation | D | E | D | E |
| Style | 0973-08838 | 6843-55006/ | 0974-80210 | 6851-50002 |
| | | 6843- | | |
| | | 55008 | | |
| yd² Blocked | 16,990 | 0 | 11,057 | 0 |
| yd² Manufactured | 1,381,904 | 17275 | 997,717 | 28519 |
| % off quality of | 1.23% | 0.00% | 1.11% | 0.00% |
| production for | | | | |
| blocking | | | | |
| Peel Force g/inch | >40 | 0 | >40 | 0 |
| Mean Bond | 659 | 1182 | 899 | 812 |
| Strength | | | | |
| PFG DJT-LAB-81 | | | | |
| Basis Weight | 65.25 | 56.23 | 46.3 | 54 |
| Uncoated | | | | |
| Basis Weight | 85.3 | 102 | 71.4 | 98.7 |
| Coated | | | | |
| Coating Add On | 20.05 | 45.77 | 25.1 | 44.7 |

It was surprisingly discovered that including a fluorochemical in a coating including chlorinated binders can cause the coating to collapse and at least partially form a more dense foam with film-like properties on the surface, which can thereby produce a denser foam that is more efficient at reducing air permeability (Table 19). As shown in Table 19, the density of the foam coating was greater and the air permeability was lower when a fluorochemical was present in a coating including a chlorinated binder compared to when the coating was devoid of a fluorochemical when applied to an unfinished 60 gsm 100% PET spunlace.

TABLE 19
Foam coating density and air permeability results for Formulation E and
Formulation F.

| | Formulation E | Formulation F |
|---|---|---|
| | (has 2.75% | (has 0% |
| Coating formulation | fluorochemical) | fluorochemical) |
| Coating Dry Add-On (gsm) | 59.9 | 58.0 |
| Overall Composite Density | 0.20 | 0.21 |
| (g/cc) | | |
| Foam Density (g/cc) | 1.08 | 0.34 |
| Air Permeability (cfm) | 7.8 | 72.2 |
| Air Permeability (Rayls) | 3314 | 254 |

It was discovered that coatings including chlorinated binders and a fluorochemical can be coated at a higher add on compared to non-chlorinated coatings to achieve very low air permeabilities (e.g., less than 10 cfm) without cracking or blocking as shown in Table 20. As shown in Table 20, Formulation E was able to provide a smooth foam surface on unfinished 60 gsm 100% PET spunlace without cracking or blocking, whereas Formulation D had a surface with many small cracks, and Formulation E achieved a lower air permeability than Formulation D. As one of skill in the art would understand, the higher the add on amount for a coating, the more likely the coating is to crack.

TABLE 20
Air permeability and appearance results with a high coating add-on.

| | Formulation | |
|---|---|---|
| Coating formulation | E | Formulation D |
| Coating Dry Add-On (gsm) | 60 | 51.5 |
| Air Permeability (cfm) | 7.8 | 10.4 |
| Air Permeability (Rayls) | 3314 | 2367 |
| Appearance | smooth foam | many small cracks |

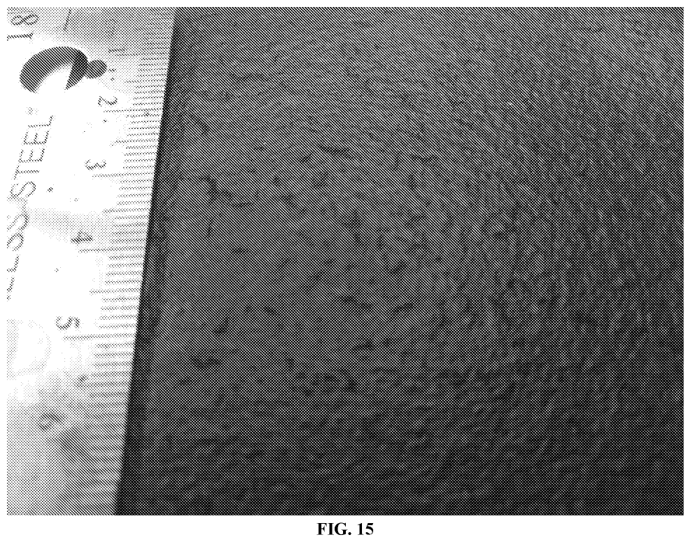

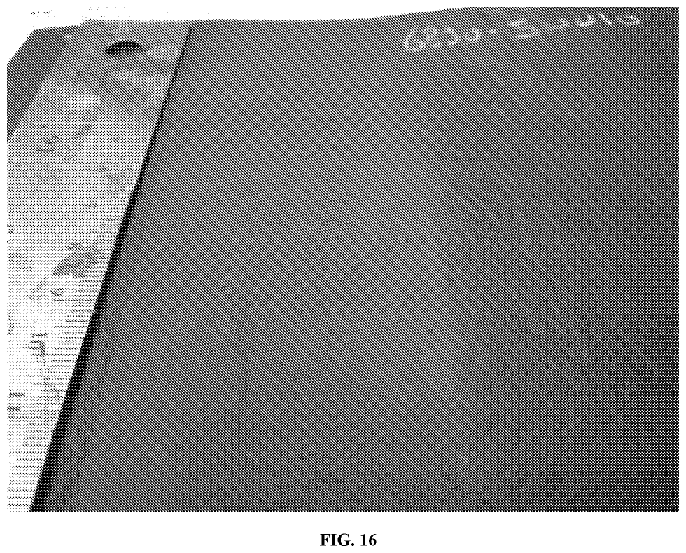

Cracking and blocking are excessive when Formulation D (which includes a styrene acrylate binder) is coated in production at high coat weights to achieve air permeability around 10 cfm. FIG. 15 is a photograph that shows cracks in a coating of the Formulation D coated at a high dry add-on of 51.5 gsm. As shown in FIG. 16, a coating of Formulation E with a coating dry add-on of 60 gsm is crack free and achieved a low air permeability (Table 19). The coating of Formulation D had an average surface roughness (Ra) of 519.9±131.67 (as measured with a Mitutoyo SJ-210) and an average gloss value of 1±0 (when measured at 60 degress with a Horiba Gloss Checker IG-331), whereas the coating of Formulation E had an average surface roughness (Ra) of 256.3±38.34 (as measured with a Mitutoyo SJ-210) and an average gloss value of 2.9±0.33 (when measured at 60 degress with a Horiba Gloss Checker IG-331).

Formulation E provided better coatings and coating/fabric composites that had differing appearances, densities, thicknesses, air permeabilities, and bond strengths compared to those of Formulation D. Composites including a coating of Formulation E included fabrics that were not treated or finished with a fluorochemical and/or flame retardant prior to the coating step. Treating a fabric with a fluorochemical makes the fabric better able to hold out the coating during the coating process. For example, as shown in Table 21, Samples 17 to 19 included fabrics that were not finished with a fluorochemical and flame retardant prior to coating. The properties of a coating referred to as Backote P1F-283 (Table 22), which is similar to Formulation E, allowed the foam coating to sit on the surface of an untreated fabric and not penetrate. Of note, Samples 17-19 were each able to pass the water drop test and had an air permeability ranging from 2.9 cfm to 30.28 cfm.

TABLE 21
Data for composites including Backote P1F-283.

| | Test | | Sample | Sample | Sample | Sample |
|---|---|---|---|---|---|---|
| | Method | Units | 17 | 18 | 19 | 20 |
| Coated | | | 6830- | 6851- | 6851- | 6843- |
| Fabric Style | | | 50010 | 50002 | 50002-2 | 55006 |
| Target Fabric | | gsm | 60 | 54 | 54 | 54 |
| Basis Weight | | | | | | |
| Fabric | | | spunlace | spunlace | spunlace | Black |
| Technology | | | | | | Finished |
| | | | | | | WP/Poly |
| | | | | | | spunlace- |
| | | | | | | two step |
| | | | | | | process |
| Fabric | | | Polyester | Polyester | polyester | Wood |
| Polymer | | | | | | pulp/ |
| | | | | | | polyester |
| Target | | gsm | 60 | 50 | 76.8 | 44 |
| Coating Add | | | | | | |
| On weight | | | | | | |
| Foam | | | ~3:1 | ~3:1 | ~3:1 | ~3:1 |
| Coating | | | | | | |
| Blow Ratio | | | | | | |
| Base | | | Backote | Backote | Backote | Backote |
| Formula | | | P1F-283 | P1F-283 | P1F-283 | P1F-283 |
| | | | Black | Black | Black | Black |
| Unidyne TG | | | 2.75% | 2.75% | 2.75% | 1.50% |
| 5502 | | | | | | |
| (fluorochemical) | | | | | | |
| Basis Weight | ASTM | gsm | 118.4 | 102.4 | 102.4 | 104.08 |
| | D3776 | | | | | |
| Width | | in | 76.6 | 76.8 | 76.8 | |
| Caliper | ASTM | in | 0.0226 | 0.0227 | 0.0227 | |
| | D1777 | | | | | |
| Tensile MD | ASTM | lbs | 43.7 | 41.5 | 41.5 | 31.247 |
| | D5034 | | | | | |
| Tensile XD | ASTM | lbs | 35.6 | 29.2 | 29.2 | 19.243 |
| | D5034 | | | | | |
| Elongation | ASTM | % | 29.1 | 35.3 | 35.3 | 19.713 |
| MD | D5034 | | | | | |
| Elongation | ASTM | % | 49.2 | 52.5 | 52.5 | 52.62 |
| XD | D5034 | | | | | |
| Trapezoidal | ASTM | lbs | 6.4 | 5.6 | 5.6 | |
| Tear MD | D5733 | | | | | |
| Trapezoidal | ASTM | lbs | 8 | 8.16 | 8.16 | |
| Tear XD | D5733 | | | | | |
| Modulus @ | ASTM | lbs | 22.3 | 17.4 | 17.4 | 19.837 |
| 10% MD | D5034 | | | | | |
| Air | ASTM | cfm | 7.8 | 23.25 | 2.9 | 30.28 |
| Permeability | D737-96 | | | | | |
| Air | ASTM | Rayls | 3591 | 1020 | TBD | 797 |
| Permeability | D737-96 | | | | | |
| Water Drop | GMW | Pass/ | Pass | Pass | Pass | Pass |
| Test 1 HR | 16522 | Fail | | | | |
| Water Drop | GMW | Pass/ | Pass | Pass | Pass | NA |
| Test 3 HR | 16522 | Fail | | | | |
| MVSS-302 | MVSS | | Self- | Self- | Self- | Pass |
| Flammability | 302 | | Extinguished | Extinguished | Extinguished | |
| MD | | | | | | |
| MVSS-302 | MVSS 302 | | Self- | Self- | Self- | Pass |
| Flammability | | | Extinguished | Extinguished | Extinguished | |
| XD | | | | | | |
| Bond | TBD | gm/in | 1229.3 | 1020.1 | 1020.1 | 1331.1 |
| Strength | | | | | | |
| 380F PFG | | | | | | |
| DJT-LAB-81 | | | | | | |
| CD | | | | | | |

TABLE 22
Formulation for BACKOTE P1F-283 (white and black version).

| | White Version | Black Version |
|---|---|---|
| Formula | (wt %) | (wt %) |
| Water | 39.75% | 39.25% |
| Dispersant (Sodium Polyacrylate) | 0.50% | 0.50% |
| Kaolin Clay (High Aspect Ratio) | 8.75% | 8.75% |
| ATH | 6.75% | 6.75% |
| Wacker CEF-52 (EVCL/VE/ | 37.50% | 37.50% |
| Acrylate Dispersion + 10Tg) | | |
| Ammonium Stearate | 2.00% | 2.00% |
| N-Octyl-Sulfosuccinamate | 2.75% | 2.75% |
| (Chemtex A18) | | |
| ALS (Chemtex A17) | 0.10% | 0.10% |
| Ammonium Hydroxide | 0.00% | 0.00% |
| Alkali Swellable Thickener | 1.30% | 1.30% |
| (Paragum 600) | | |
| Alkali Swellable Thickener | 0.50% | 0.50% |
| (Paragum 601) | | |
| Biocide | 0.10% | 0.10% |
| Carbon Black Dispersion | | 0.50% |
| Total | 100.00% | 100.00% |
| Unidyne TG 5502 | Varies from 1.3% | Varies from 1.3% |
| | to 2.75% by | to 2.75% by |
| | weight based on | weight based on |
| | the weight of the | the weight of the |
| | above | above |
| | formulation | formulation |

As demonstrated by the above data, coatings of the present invention are versatile and can be designed to meet end use properties desirable for various acoustic attenuation problems, especially those encountered in automotive, equipment and construction applications. As can be seen from the above data, basis weight, caliper, tensile strength, elongation at break, trapezoidal tear, modulus, air permeability, water drop holdout, MVSS 302 flammability and strength of bonding to a surface can be adjusted. For example, the strength and elongation characteristics of a coated fabric composite may primarily be derived from the base fabric, while the air permeability, water hold out, bonding strength and to some extent modulus, flammability and trapezoidal tear may be derived from the coating.

The foregoing is illustrative of the present invention, and is not to be construed as limiting thereof. The invention is defined by the following claims, with equivalents of the claims to be included therein.

1. A porous polymer coating comprising:
a polymeric foam having thermally activated adhesive properties, a void fraction of greater than about 15%, and an air permeability greater than 3 cubic feet per minute per square foot as measured based on ASTM D737-04, wherein the polymeric foam comprises a clay and/or pigment, optionally wherein the clay and/or pigment has an aspect ratio of about 2:1, to about 100:1.

2. The porous polymer coating of claim 1, wherein the clay and/or pigment is present in an amount of about 1% to about 40% by dry weight of the final solids content of the polymeric foam or coating.

3. The porous polymer coating of claim 1, wherein the clay and/or pigment has one or more of the following properties: a particle size of about 0.001 μto about 100 μm, a whiteness (as quantified by L value as quantified by L value using TAPPI Test Method T 560) of about 70 to about 100, a brightness (as quantified by as quantified using TAPPI Test Method T 452) of about 70, to about 100, a hardness (quantified in accordance with the Mohs Hardness Test and Scale) of about 2 to about 5, and/or a mean refractive index of about 1.50 to about 1.60.

4. The porous polymer coating of claim 1, wherein said polymeric foam comprises one or more thermoplastic polymers, one or more non-thermoplastic polymers, one or more thermoset polymers, and/or one or more latex binders.

5. The porous polymer coating of claim 1, wherein said porous polymer coating comprises one or more surfactants.

6. The porous polymer coating of claim 1, wherein said porous polymer coating comprises a polymer having a glass transition temperature in a range of about −10 to about +35.

7. The porous polymer coating of claim 1, wherein said porous polymer coating comprises a polymer having a chlorine content in a range of about 10% to about 60%.

8. The porous polymer coating of claim 1, wherein said porous polymer coating comprises a polyvinylchloride (PVC), ethylene-vinyl chloride (EVCL), vinyl chloride ethylene vinyl ester acrylate terpolymer, ethylene-vinyl chloride vinyl acetate, polyvinylidene chloride (PVDC), and/or polyvinyl chloride acrylic copolymer.

9. The porous polymer coating of claim 1, further comprising a fluorochemical.

10. The porous polymer coating of claim 1, wherein the porous polymer coating has a density of less than about 2 g/cc.

11. The porous polymer coating of claim 1, wherein the porous polymer coating has an air permeability and/or airflow resistance after exposing the porous polymer coating to a temperature of about 300° F. or 350° F. to about 400° F. or 500° F. for optionally about 30 seconds to about 3 minutes that changes by less than about ±25% of the air permeability and/or airflow resistance of the porous polymer coating prior to exposing the porous polymer coating to a temperature of about 300° F. or 350° F. to about 400° F. or 500° F. for optionally about 30 seconds to about 3 minutes.

12. The porous polymer coating of claim 1, having an airflow resistance of greater than about 250, 500, 1,000, or 10,000 Rayls as measured based on ASTM C522-03.

13. The porous polymer coating of preceding claim 1, having an air permeability of greater than about 22, 40, or 73 cubic feet per minute per square foot as measured based on ASTM D737-04.

14. The porous polymer coating of claim 1, wherein the porous polymer coating has a basis weight of about 10 grams per square meter to about 45 or 75 grams per square meter.

15. The porous polymer coating of claim 1, wherein the porous polymer coating passes flame retardancy test MVSS 302.

16. The porous polymer coating of claim 1, wherein the polymeric foam is a reticulated polymeric foam.

17. The porous polymer coating of claim 1, further comprising thermally activatable adhesive particles.

18. (canceled)

19. The porous polymer coating of claim 1, further comprising a substrate, wherein the coating is present on at least a portion of a surface the substrate.

20. A composite material, comprising:
a first substrate;
a second substrate; and
the porous polymer coating of claim 1 interposed between said first substrate and second substrate.

21-31. (canceled)

32. A method of forming a composite material, comprising:
applying the porous polymer coating of claim 1 to a substrate.

33-42. (canceled)
